(19) United States
(12) Patent Application Publication
(10) Pub. No.: US 2025/0180743 A1
(43) Pub. Date: Jun. 5, 2025

(54) HIGH RESOLUTION COHERENT LIDAR SYSTEMS, AND RELATED METHODS AND APPARATUS

(71) Applicant: VELODYNE LIDAR USA, INC., San Jose, CA (US)

(72) Inventors: Sunil Kumar Singh KHATANA, Sunnyvale, CA (US); Mathew Noel REKOW, Santa Cruz, CA (US)

(21) Appl. No.: 18/686,262

(22) PCT Filed: Sep. 1, 2022
(86) PCT No.: PCT/US2022/075868

§ 371 Date: Feb. 23, 2024

Related U.S. Application Data
(60) Provisional application No. 63/239,807, filed on Sep. 1, 2021.

(51) Int. Cl. G01S 17/89; G01S 7/484; G01S 7/487

(52) U.S. Cl. CPC G01S 17/89; G01S 7/484; G01S 7/487

(57) ABSTRACT

A lidar method may include transmitting, by a transmitter of a lidar sensor, a light signal into a portion of an environment along one direction within a time period, wherein the light signal changes within the time period over a frequency band at a particular frequency rate; receiving, by a receiver of the lidar sensor, a return signal corresponding to the light signal; and by a processor of the lidar sensor, generating a sequence of samples based on the light signal and the return signal, and generating a series of data points, in a point cloud, corresponding to a series of environmental points in the portion of the environment, wherein the data points are generated by performing a sliding discrete Fourier transform (DFT) on the sequence of samples, wherein each of the data points indicates a respective range to the corresponding environmental point.

### CROSS-REFERENCE TO RELATED APPLICATIONS

This application claims the benefit and priority under 35 U.S.C. § 119 (e) of U.S. Provisional Patent Application No. 63/239,807 titled “High Resolution Coherent Lidar Systems, and Related Methods and Apparatus” and filed on Sep. 1, 2021, which is hereby incorporated by reference herein in its entirety.

### FIELD OF TECHNOLOGY

The present disclosure relates to coherent light detection and ranging (lidar) systems and, in particular, high-resolution frequency-modulated continuous wave (FMCW) coherent lidar systems and methods.

### BACKGROUND

Lidar systems measure the attributes of their surrounding environments (e.g., shape of a target, contour of a target, distance to a target, etc.) by illuminating the environment with light (e.g., laser light) and measuring the reflected light with sensors. Differences in laser return times and/or wavelengths can then be used to make digital, three-dimensional (“3D”) representations of a surrounding environment. Lidar technology may be used in various applications including autonomous vehicles, advanced driver assistance systems, mapping, security, surveying, robotics, geology and soil science, agriculture, unmanned aerial vehicles, airborne obstacle detection (e.g., obstacle detection systems for aircraft), etc. Depending on the application and associated field of view, multiple channels or laser beams may be used to produce images in a desired resolution. A lidar system with greater numbers of channels can generally generate larger numbers of pixels.

In a multi-channel lidar device, optical transmitters can be paired with optical receivers to form multiple “channels.” In operation, each channel's transmitter can emit an optical signal (e.g., laser) into the device's environment, and the channel's receiver can detect the portion of the signal that is reflected back to the channel by the surrounding environment. In this way, each channel can provide “point” measurements of the environment, which can be aggregated with the point measurements provided by the other channel(s) to form a “point cloud” of measurements of the environment.

The measurements collected by a lidar channel may be used to determine the distance (“range”) from the device to the surface in the environment that reflected the channel's transmitted optical signal back to the channel's receiver. In some cases, the range to a surface may be determined based on the time of flight of the channel's signal (e.g., the time elapsed from the transmitter's emission of the optical signal to the receiver's reception of the return signal reflected by the surface). In other cases, the range may be determined based on the frequency (or wavelength) of the return signal(s) reflected by the surface.

In some cases, lidar measurements may be used to determine the reflectance of the surface that reflects an optical signal. The reflectance of a surface may be determined based on the intensity of the return signal, which generally depends not only on the reflectance of the surface but also on the range to the surface, the emitted signal's glancing angle with respect to the surface, the power level of the channel's transmitter, the alignment of the channel's transmitter and receiver, and other factors.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

According to an aspect of the present disclosure, a lidar method includes transmitting, by a transmitter of a lidar sensor, a light signal into a portion of an environment along one direction within a time period, wherein the light signal changes within the time period over a frequency band at a particular frequency rate; receiving, by a receiver of the lidar sensor, a return signal corresponding to the light signal; and by a processor of the lidar sensor, generating a sequence of samples based on the light signal and the return signal, and generating a series of data points, in a point cloud, corresponding to a series of environmental points in the portion of the environment, wherein the data points are generated by performing a sliding discrete Fourier transform (DFT) on the sequence of samples, wherein each of the data points indicates a respective range to the corresponding environmental point.

According to another aspect of the present disclosure a lidar method includes transmitting, by a transmitter of a lidar sensor, a first light signal and a second light signal into a first portion of an environment along a first direction within a first time period, wherein the first light signal changes within the first time period over a first frequency band at a first frequency rate, and wherein the second light signal changes within the first time period over a second frequency band at a second frequency rate; receiving, by a receiver of the lidar sensor, a first return signal corresponding to the first light signal and a second return signal corresponding to the second light signal; and by a processor of the lidar sensor, generating a sequence of samples based on the first light signal, the first return signal, the second light signal, and the second return signal, generating a series of data points, in a point cloud, corresponding to a series of environmental points in the portion of the environment, wherein the data points are generated by performing a sliding discrete Fourier transform (DFT) on the sequence of samples, wherein each of the data points indicates a respective range to the corresponding environmental point and/or a respective velocity of the corresponding environmental point.

According to another aspect of the present disclosure, a lidar device includes a first light source configured to emit a first light signal changing within a first time period over a first frequency band at a first frequency rate, and a second light source configured to emit a second light signal changing within the first time period over a second frequency band at a second frequency rate; a first light splitter configured to split the first light signal into a first split light signal directed into a scanner and a second split light signal directed into a first mixer, and a second light splitter configured to split the second light signal into a third split light signal directed into the scanner and a fourth split light signal directed into a second mixer; the scanner configured to direct the first split light signal into an environment and receive a first return signal returning from the environment, and direct the third split light signal into the environment and receive a second return signal returning from the environment, the first split light signal and the third split light signal being directed to a first portion of the environment along a first direction within the first time period; the first mixer configured to mix the second split light signal with the first return signal to generate a first mixed signal with a first beat frequency, and the second mixer configured to mix the fourth split light signal with the second return signal to generate a second mixed signal with a second beat frequency; and a processor configured to generate a first series of data points, in a point cloud, corresponding to a first series of environmental points in the first portion of the environment based on the first mixed signal with the first beat frequency and the second mixed signal with the second beat frequency, wherein each of the first series of data points includes a measurement of range and/or velocity of the first series of environment points scanned by the scanner within the first time period.

According to another aspect of the present disclosure, a lidar device includes a first light source configured to emit a first light signal changing within a first time period at a first frequency rate over a first frequency band, and a second light source configured to emit a second light signal changing within the first time period at a second frequency rate over a second frequency band; a combiner configured to combine the first light signal and the second light signal to generate a first combined light signal; a splitter configured to split the first combined light signal into a first split light signal and a second split light signal; a scanner configured to direct the first split light signal into an environment, and receive a first return light signal returning from the environment, the first split light signal being directed to a first portion of the environment along a first direction; a mixer configured to mix the first return light signal and the second split light signal to generate a first mixed signal with a first beat frequency corresponding to the first light signal and a second beat frequency corresponding to the second light signal; and a processor configured to generate a first series of data points, in a point cloud, corresponding to a first series of environmental points in the first portion of the environment based on the first mixed signal with the first beat frequency and the second beat frequency, wherein each of the first series of data points includes a measurement of range and/or velocity of the first series of environment points scanned by the scanner within the first time period.

According to another aspect of the present disclosure, a method for operating a lidar device includes providing, via a first light source, a first light signal changing within a first time period over a first frequency band at a first frequency rate, and providing, via a second light source, a second light signal changing within the first time period over a second frequency band at a second frequency rate; splitting, via a first splitter, the first light signal into a first split light signal, directed into an environment via a scanner, and a second split light signal directed into a first mixer, and splitting, via a second splitter, the second light signal into a third split light signal, directed into the environment via the scanner, and a fourth split light signal directed into a second mixer, the first split light signal and the third split light signal being directed towards a portion of the environment along a first direction; receiving, via the scanner, a first return signal corresponding to the first split light signal and a second return signal corresponding to the third split light signal; mixing, via the first mixer, the second split light signal with the first return signal to generate a first mixed signal with a first beat frequency, and mixing, via the second mixer, the fourth split light signal with the second return signal to generate a second mixed signal with a second beat frequency; and determining, by a processor, a series of data points, in a point cloud, corresponding to a series of environmental points in the portion of the environment based on the first mixed signal with the first beat frequency and the second mixed signal with the second beat frequency, wherein each of the series of data points includes a measurement of range and/or velocity of the series of environment points scanned by the scanner within the first time period.

According to another aspect of the present disclosure, a method for operating a lidar device includes providing, via a first light source, a first light signal changing within a first time period over a first frequency band at a first frequency rate, and providing, via a second light source, a second light signal changing within the first time period over a second frequency band at a second frequency rate; combining, via a combiner, the first light signal and the second light signal to generate a combined light signal; splitting, via a splitter, the combined light signal into a first split light signal and a second split light signal; directing, via a scanner, the first split light signal into an environment, and receiving, via the scanner, a return light signal returning from the environment, the first split light signal being directed to a portion of the environment along a first direction; mixing, via a mixer, the return light signal with the second split light signal to generate a mixed signal with a first beat frequency corresponding to the first light signal and a second beat frequency corresponding to the second light signal; and determining, by a processor, a series of data points, in a point cloud, corresponding to a series of environmental points in the portion of the environment based on the mixed signal with the first beat frequency and the second beat frequency, wherein each of the series of data points includes a measurement of range and/or velocity of the series of environment points scanned by the scanner within the first time period.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the in present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 shows an illustration of an exemplary lidar system, in accordance with some embodiments.

FIG. 2A shows an illustration of the operation of a lidar system, in accordance with some embodiments.

FIG. 2B shows an illustration of optical components of a channel of a lidar system with a movable mirror, in accordance with some embodiments.

FIG. 2C is an illustration of an example of a three-dimensional (“3D”) lidar system, in accordance with some embodiments.

FIG. 3 is an illustration of an example continuous wave (CW) coherent lidar system, in accordance with some embodiments.

FIG. 4 is a diagram of a processing method for generating a point cloud over a field-of-view (FOV) of a lidar system, in accordance with some embodiments.

FIG. 5 is a diagram of another processing method for generating a point cloud over a FOV of a lidar system, in accordance with some embodiments.

FIG. 6 is a diagram of yet another processing method for generating a point cloud over a FOV of a lidar system, in accordance with some embodiments.

FIG. 7 is an illustration of an example frequency modulated continuous wave (FMCW) coherent lidar system, in accordance with some embodiments.

FIG. 8A is a plot of a frequency chirp as a function of time in a transmitted laser signal and reflected signal, in accordance with some embodiments.

FIG. 8B is a plot illustrating a beat frequency of a mixed signal, in accordance with some embodiments.

FIG. 9 is a diagram of an FMCW coherent lidar system configured to determine the range and/or speed of a target, in accordance with some embodiments.

FIG. 10A is a diagram of another FMCW coherent lidar system configured to determine the range and/or speed of a target, in accordance with some embodiments.

FIG. 10B includes a plot illustrating a laser wavelength scheme, in accordance with some embodiments.

FIG. 11 is a diagram of a method for operating an FMCW coherent lidar system, in accordance with some embodiments.

FIG. 12 includes several plots illustrating a chirp scheme, in accordance with some embodiments.

FIG. 13 includes several plots illustrating another chirp scheme, in accordance with some embodiments.

FIG. 14 includes several plots illustrating yet another chirp scheme, in accordance with some embodiments.

FIG. 15 is a diagram of yet another FMCW coherent lidar system configured to determine the range and/or speed of a target, in accordance with some embodiments.

FIG. 16A is a diagram of a vehicle including a plurality of sensors in accordance with aspects described herein, in accordance with some embodiments.

FIG. 16B is a block diagram of a silicon photonic integrated circuit (PIC), in accordance with some embodiments.

FIG. 17 shows a block diagram of a computing device/information handling system, in accordance with some embodiments.

FIG. 18 is a block diagram of an example computer system, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

High resolution coherent lidar systems and related methods and apparatus are provided herein. One or more exemplary high-resolution FMCW coherent lidar systems and/or methods may be used by autonomous or semi-autonomous vehicles, including passenger vehicles, industrial robots, aerial vehicles, underwater vehicles, etc., for the detection of objects and/or navigation through space. The following description of the exemplary lidar systems and methods may be in the context of autonomous vehicles but it is understood that the same principles can be applied to other applications and contexts in which object detection and/or navigation are performed.

It will be appreciated that, for simplicity and clarity of illustration, where considered appropriate, reference numerals may be repeated among the figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details.

### Motivation for and Benefits of Some Embodiments

FMCW coherent lidar systems can be used to simultaneously measure the distance (range) to a point and its relative velocity by increasing or decreasing the frequency of the transmitted optical signal over time (also referred to as “chirping”) and by measuring the differences in phase or frequency between the transmitted and received optical signals. Compared to other lidar systems, FMCW coherent lidar systems can mitigate or avoid the eye safety hazards commonly associated with pulsed lidar systems (e.g., hazards that arise from transmitting optical signals with high peak power). In addition, coherent detection may be more sensitive than direct detection and can offer better performance, including single-pulse velocity measurement and greater immunity to interference from solar glare and other light sources, including other lidar sensors.

Some FMCW coherent lidar systems may rely on emission of two short “chirps” (optical signals with increasing or decreasing frequency) to generate range and velocity measurements at each individual point. Here, “short chirp” refers to a chirp with a relatively short time duration. In some cases, for each point measurement, such systems may emit a first short chirp C1 with a frequency that changes at a first rate R1, followed immediately by a second short chip C2 with a frequency that changes at a second rate R2. For example, the chirp C1 may have an increasing frequency, and the chirp C2 may have a decreasing frequency. In such systems, the scan resolution is limited by the time required to emit two consecutive chirps with different frequency slopes. The resulting scan resolution may be insufficient for many lidar applications.

To address this problem, some exemplary FMCW coherent lidar systems disclosed herein may rely on the simultaneous emission of two “long chirps” having different frequency slopes (e.g., negative and positive slopes) to generate range and velocity measurements for multiple points with high resolution. Here, “long chirp” refers to a chirp with a relatively long time duration. For example, an exemplary FMCW coherent lidar system may simultaneously emit two long chirps with different slopes to scan an entire scan line of points in the system's field of view, with high resolution. In addition, by eliminating the need for frequent short chirping, this approach simplifies the control of the operation of the lidar system.

In cases in which the environment being scanned is static (e.g., all objects in the environment are stationary), a single “long chirp” (rather than a pair of long chirps) may be used to generate range measurements for multiple points with high resolution. Thus, some exemplary FMCW coherent lidar systems may rely on emission of a sequence of individual “long chirps” to scan a static environment. In some cases, each “long chirp” may correspond to a single scan line of the lidar system's scan pattern. Other advantages of the disclosed lidar systems become apparent in view of the descriptions of the specific embodiments.

### Some Examples of Lidar Systems

A lidar system may be used to measure the shape and contour of the environment surrounding the system. Lidar systems may be applied to numerous applications including autonomous navigation and aerial mapping of surfaces. In general, a lidar system emits light that is subsequently reflected by objects within the environment in which the system operates. In some examples, the lidar system is configured to emit light pulses. The time each pulse travels from being emitted to being received (i.e., time-of-flight, “TOF” or “ToF”) may be measured to determine the distance between the lidar system and the object that reflects the pulse. In other examples, the lidar system can be configured to emit continuous wave (CW) light. The wavelength (or frequency) of the received, reflected light may be measured to determine the distance between the lidar system and the object that reflects the light. In some examples, lidar systems can measure the speed (or velocity) of objects. The science of lidar systems is based on the physics of light and optics.

In a lidar system, light may be emitted from a rapidly firing laser. Laser light travels through a medium and reflects off points of surfaces in the environment (e.g., surfaces of buildings, tree branches, vehicles, etc.). The reflected light energy returns to a lidar detector where it may be recorded and used to map the environment.

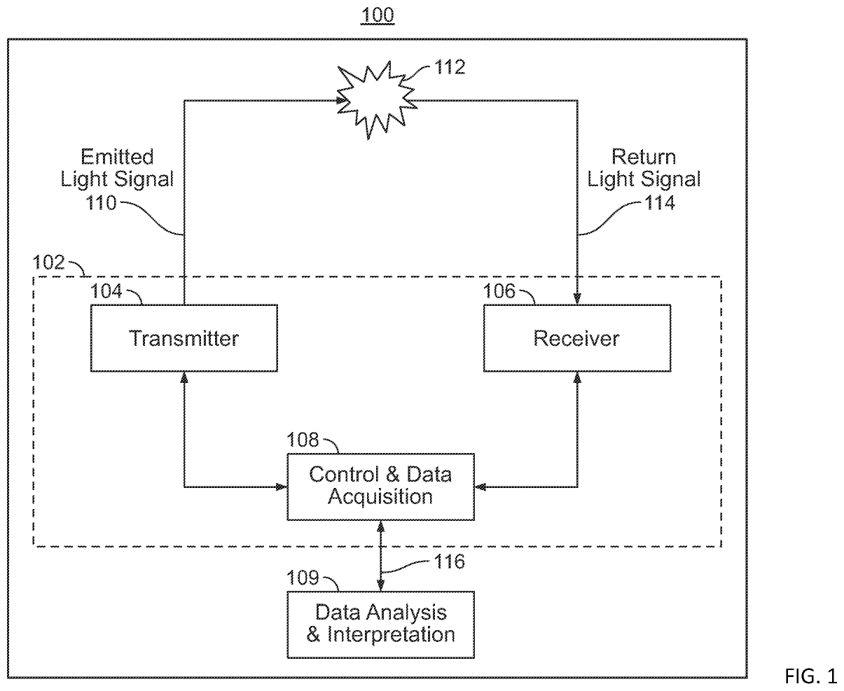

FIG. 1 depicts the operation of a lidar system 100, according to some embodiments. In the example of FIG. 1, the lidar system 100 includes a lidar device 102, which may include a transmitter 104 that generates and emits a light signal 110, a receiver 106 that detects a return light signal 114, and a control & data acquisition module 108. The transmitter 104 may include a light source (e.g., laser), electrical components operable to activate (e.g., drive) and deactivate the light source in response to electrical control signals, and optical components adapted to shape and redirect the light emitted by the light source. The receiver 106 may include an optical detector (e.g., photodiode) and optical components adapted to shape return light signals 114 and direct those signals to the detector. In some implementations, one or more optical components (e.g., lenses, mirrors, etc.) may be shared by the transmitter and the receiver. The lidar device 102 may be referred to as a lidar transceiver or “channel.” In operation, the emitted (e.g., illumination) light signal 110 propagates through a medium and reflects off an object(s) 112, whereby a return light signal 114 propagates through the medium and is received by receiver 106. In one example, each lidar channel may correspond to a physical mapping of a single emitter to a single detector (e.g., a one-to-one pairing of a particular emitter and a particular detector). However, in other examples, each lidar channel may correspond to a physical mapping of multiple emitters to a single detector or a physical mapping of a single emitter to multiple detectors (e.g., a “flash” configuration). In some examples, a lidar system 100 may have no fixed channels; rather, light emitted by one or more emitters may be detected by one or more detectors without any physical or persistent mapping of specific emitters to specific detectors.

Any suitable light source may be used including, without limitation, laser diode, vertical-cavity surface emitting laser (VCSEL), fiber laser, pulsed laser, Q-switched laser, etc. The light source may emit light having any suitable wavelength or wavelengths (e.g., 400-1600 nm). Any suitable optical detector may be used including, without limitation, photodetector, photodiode, avalanche photodiode (APD), single-photon avalanche diode (SPAD), photomultiplier, etc.

The control & data acquisition module 108 may control the light emission by the transmitter 104 and may record data derived from the return light signal 114 detected by the receiver 106. In some embodiments, the control & data acquisition module 108 controls the power level at which the transmitter 104 operates when emitting light. For example, the transmitter 104 may be configured to operate at a plurality of different power levels, and the control & data acquisition module 108 may select the power level at which the transmitter 104 operates at any given time. Any suitable technique may be used to control the power level at which the transmitter 104 operates. In some embodiments, the control & data acquisition module 108 determines (e.g., measures) particular characteristics of the return light signal 114 detected by the receiver 106. For example, the control & data acquisition module 108 may measure the intensity of the return light signal 114 using any suitable technique.

A lidar transceiver 102 may include one or more optical lenses and/or mirrors (not shown) to redirect and shape the emitted light signal 110 and/or to redirect and shape the return light signal 114. The transmitter 104 may emit a laser beam (e.g., a beam having a plurality of pulses in a particular sequence). Design elements of the receiver 106 may include its horizontal field of view (hereinafter, “FOV”) and its vertical FOV. One skilled in the art will recognize that the FOV parameters effectively define the visibility region relating to the specific lidar transceiver 102. More generally, the horizontal and vertical FOVs of a lidar system 100 may be defined by a single lidar device (e.g., sensor) or may relate to a plurality of configurable sensors (which may be exclusively lidar sensors or may have different types of sensors). The FOV may be considered a scanning area for a lidar system 100. A scanning mirror and/or rotating assembly may be utilized to obtain a scanned FOV.

In some implementations, the lidar system 100 may include or be electronically coupled to a data analysis & interpretation module 109, which may receive outputs (e.g., via connection 116) from the control & data acquisition module 108 and perform data analysis functions on those outputs. The connection 116 may be implemented using a wireless or non-contact communication technique.

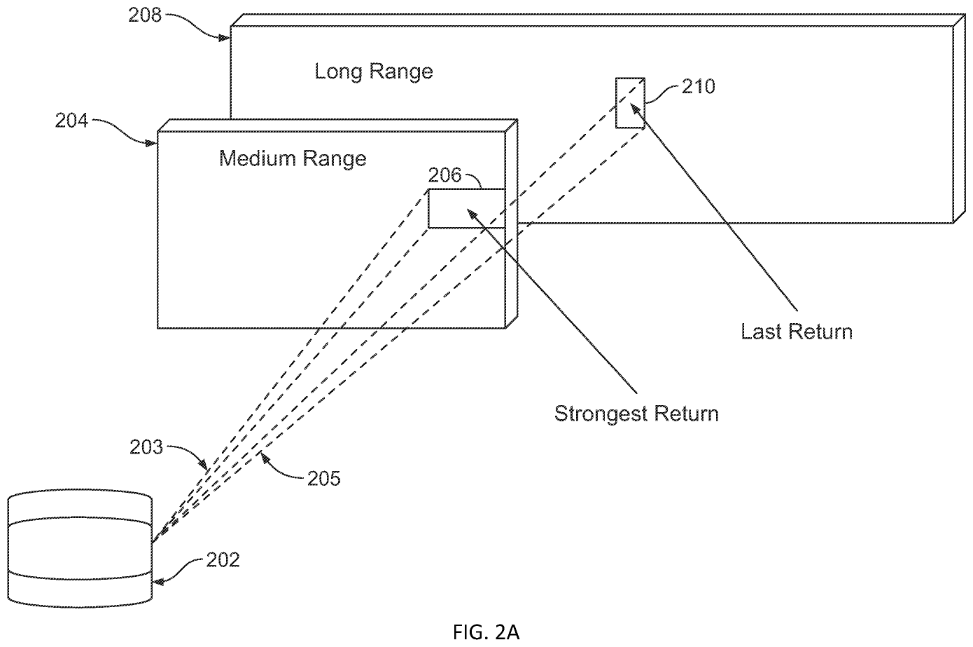

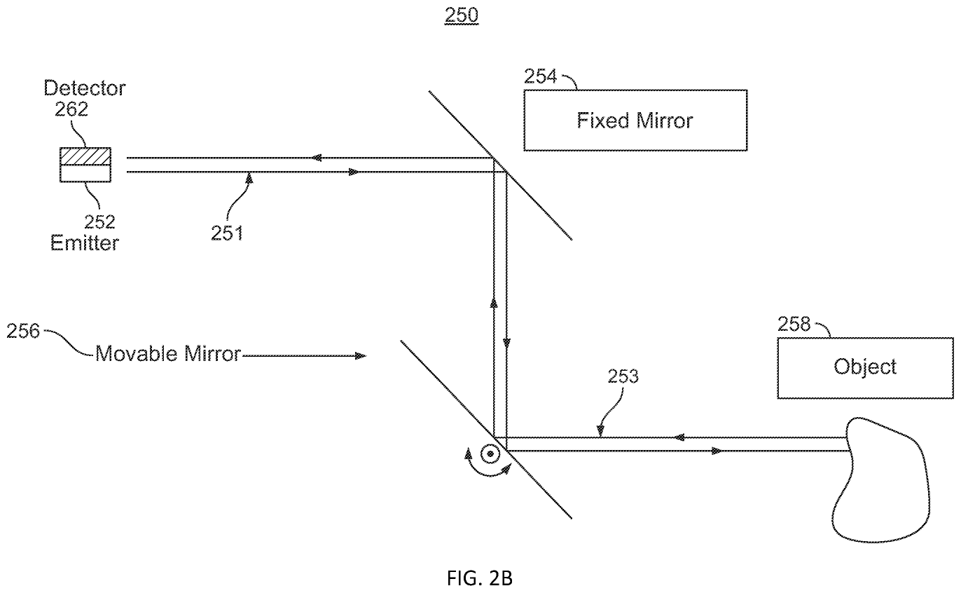

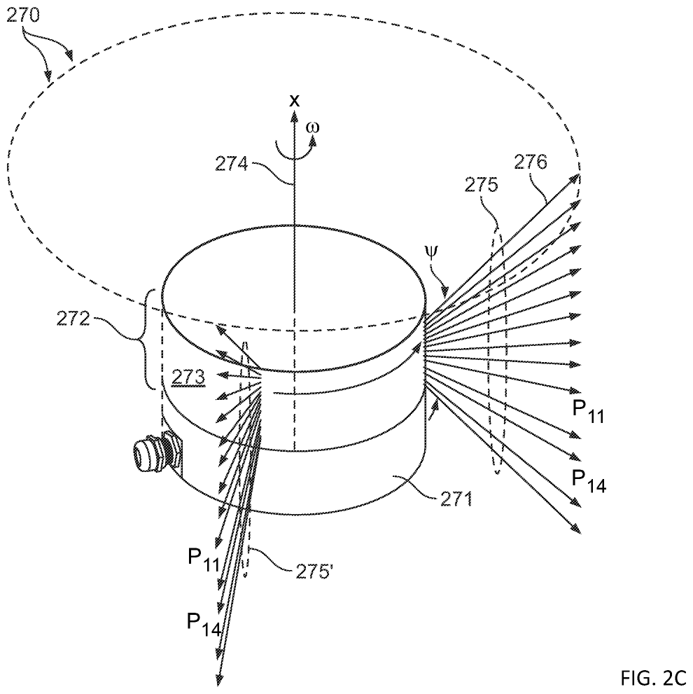

FIG. 2A illustrates the operation of a lidar system 202, in accordance with some embodiments. In the example of FIG. 2A, two return light signals 203 and 205 are shown. Laser beams generally tend to diverge as they travel through a medium. Due to the laser's beam divergence, a single laser emission may hit multiple objects at different ranges from the lidar system 202, producing multiple return signals 203, 205. The lidar system 202 may analyze multiple return signals 203, 205 and report one of the return signals (e.g., the strongest return signal, the last return signal, etc.) or more than one (e.g., all) of the return signals. In the example of FIG. 2A, lidar system 202 emits laser light in the direction of near wall 204 and far wall 208. As illustrated, the majority of the emitted light hits the near wall 204 at area 206 resulting in a return signal 203, and another portion of the emitted light hits the far wall 208 at area 210 resulting in a return signal 205. Return signal 203 may have a shorter TOF and a stronger received signal strength compared with return signal 205. In both single- and multiple-return lidar systems, it is important that each return signal is accurately associated with the transmitted light signal so that one or more attributes of the object that reflect the light signal (e.g., range, velocity, reflectance, etc.) can be correctly calculated.

Some embodiments of a lidar system may capture distance data in a two-dimensional (2D) (e.g., single plane) point cloud manner. These lidar systems may be used in industrial applications, or for surveying, mapping, autonomous navigation, and other uses. Some embodiments of these systems rely on the use of a single laser emitter/detector pair combined with a moving mirror to effect scanning across at least one plane. This mirror may reflect the emitted light from the transmitter (e.g., laser diode), and/or may reflect the return light to the receiver (e.g., to the detector). Use of a movable (e.g., oscillating) mirror in this manner may enable the lidar system to achieve 90-180-360 degrees of azimuth (horizontal) view while simplifying both the system design and manufacturability. Many applications require more data than just a 2D plane. The 2D point cloud may be expanded to form a three-dimensional (“3D”) point cloud, in which multiple 2D point clouds are used, each pointing at a different elevation (e.g., vertical) angle. Design elements of the receiver of the lidar system 202 may include the horizontal FOV and the vertical FOV.

FIG. 2B depicts a lidar system 250 with a movable (e.g., oscillating) mirror, according to some embodiments. In the example of FIG. 2B, the lidar system 250 uses a single emitter 252/detector 262 pair combined with a fixed mirror 254 and a movable mirror 256 to effectively scan across a plane. Distance measurements obtained by such a system may be effectively two-dimensional (e.g., planar), and the captured distance points may be rendered as a 2D (e.g., single plane) point cloud. In some embodiments, but without limitation, the movable mirror 256 may oscillate at very fast speeds (e.g., thousands of cycles per minute).

The emitted laser signal 251 may be directed to a fixed mirror 254, which may reflect the emitted laser signal 251 to the movable mirror 256. As movable mirror 256 moves (e.g., oscillates), the emitted laser signal 251 may reflect off an object 258 in its propagation path. The reflected return signal 253 may be coupled to the detector 262 via the movable mirror 256 and the fixed mirror 254. Design elements of the lidar system 250 include the horizontal FOV and the vertical FOV, which define a scanning area. In some embodiments, the movable mirror functionality is implemented with a solid state technology (e.g., microelectromechanical systems or “MEMS”).

FIG. 2C depicts a 3D lidar system 270, according to some embodiments. In the example of FIG. 2C, the 3D lidar system 270 includes a lower housing 271 and an upper housing 272. The upper housing 272 includes a cylindrical shell element 273 constructed from a material that is transparent to infrared light (e.g., light having a wavelength within the spectral range of 700 to 1,700 nanometers). In one example, the cylindrical shell element 273 is transparent to light having wavelengths centered at 905 nanometers.

In some embodiments, the 3D lidar system 270 includes a lidar transceiver 102 operable to emit laser beams 276 through the cylindrical shell element 273 of the upper housing 272. In the example of FIG. 2C, each individual arrow in the sets of arrows 275, 275′ directed outward from the 3D lidar system 270 represents a laser beam 276 emitted by the 3D lidar system. Each beam of light emitted from the system 270 may diverge slightly, such that each beam of emitted light forms a cone of illumination light emitted from system 270. In one example, a beam of light emitted from the system 270 illuminates a spot size of 20 centimeters in diameter at a distance of 100 meters from the system 270.

In some embodiments, the transceiver 102 emits each laser beam 276 transmitted by the 3D lidar system 270. The direction of each emitted beam may be determined by the angular orientation ω of the transceiver's transmitter 104 with respect to the system's central axis 274 and by the angular orientation ψ of the transmitter's movable mirror 256 with respect to the mirror's axis of oscillation (or rotation). For example, the direction of an emitted beam in a horizontal dimension may be determined by the transmitter's angular orientation ω, and the direction of the emitted beam in a vertical dimension may be determined by the angular orientation ψ of the transmitter's movable mirror. Alternatively, the direction of an emitted beam in a vertical dimension may be determined the transmitter's angular orientation ω, and the direction of the emitted beam in a horizontal dimension may be determined by the angular orientation ψ of the transmitter's movable mirror. (For purposes of illustration, the beams of light 275 are illustrated in one angular orientation relative to a non-rotating coordinate frame of the 3D lidar system 270 and the beams of light 275′ are illustrated in another angular orientation relative to the non-rotating coordinate frame.)

The 3D lidar system 270 may scan a particular point (e.g., pixel) in its field of view by adjusting the orientation ω of the transmitter and the orientation ψ of the transmitter's movable mirror to the desired scan point (ω, ψ) and emitting a laser beam from the transmitter 104. Likewise, the 3D lidar system 270 may systematically scan its field of view by adjusting the orientation ω of the transmitter and the orientation ψ of the transmitter's movable mirror to a set of scan points (ωᵢ, ψⱼ) and emitting a laser beam from the transmitter 104 at each of the scan points.

Assuming that the optical component(s) (e.g., movable mirror 256) of a lidar transceiver remain stationary during the time period after the transmitter 104 emits a laser beam 110 (e.g., a pulsed laser beam or “pulse” or a CW laser beam) and before the receiver 106 receives the corresponding return beam 114, the return beam generally forms a spot centered at (or near) a stationary location LO on the detector. This time period is referred to herein as the “ranging period” of the scan point associated with the transmitted beam 110 and the return beam 114.

In many lidar systems, the optical component(s) of a lidar transceiver do not remain stationary during the ranging period of a scan point. Rather, during a scan point's ranging period, the optical component(s) may be moved to orientation(s) associated with one or more other scan points, and the laser beams that scan those other scan points may be transmitted. In such systems, absent compensation, the location “Li” of the center of the spot at which the transceiver's detector receives a return beam 114 generally depends on the change in the orientation of the transceiver's optical component(s) during the ranging period, which depends on the angular scan rate (e.g., the rate of angular motion of the movable mirror 256) and the range to the object 112 that reflects the transmitted light. The distance between the location Li of the spot formed by the return beam and the nominal location LO of the spot that would have been formed absent the intervening rotation of the optical component(s) during the ranging period is referred to herein as “walk-off.”

### Some Examples of Continuous Wave (CW) Lidar Systems

As discussed above, some lidar systems may use a continuous wave (CW) laser to detect the range and/or velocity of targets, rather than pulsed TOF techniques. Such systems include continuous wave (CW) coherent lidar systems and frequency modulated continuous wave (FMCW) coherent lidar systems. For example, any of the lidar systems 100, 202, 250, and 270 described above can be configured to operate as a CW coherent lidar system or an FMCW coherent lidar system.

Lidar systems configured to operate as CW or FMCW systems can avoid the eye safety hazards commonly associated with pulsed lidar systems (e.g., hazards that arise from transmitting optical signals with high peak power). In addition, coherent detection may be more sensitive than direct detection and can offer better performance, including single-pulse velocity measurement and immunity to interference from solar glare and other light sources, including other lidar systems and devices.

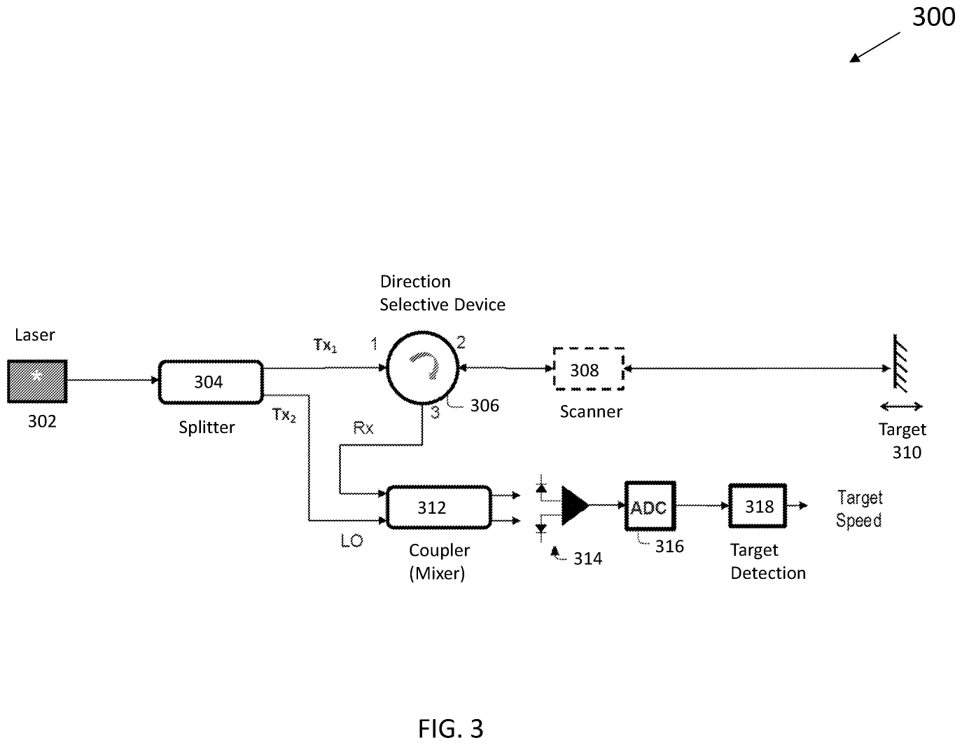

FIG. 3 illustrates an exemplary CW coherent lidar system 300 configured to determine the radial velocity (or speed) of a target. Lidar system 300 includes a laser 302 configured to produce a laser signal which is provided to a splitter 304. The laser 302 may provide a laser signal having a substantially constant laser frequency.

In one example, a splitter 304 provides a first split laser signal Tx1 to a direction selective device 306, which provides (e.g., forwards) the signal Tx1 to a scanner 308. In some examples, the direction selective device 306 is a circulator. The scanner 308 uses the first laser signal Tx1 to transmit light emitted by the laser 302 and receives light reflected by the target 310 (e.g., “reflected light” or “reflections”). The reflected light signal Rx is provided (e.g., passed back) to the direction selective device 306. The second laser signal Tx2 (provided by the splitter 304) and the reflected light signal Rx are provided to a coupler (also referred to as a mixer) 312. The mixer may use the second laser signal Tx2 as a local oscillator (LO) signal and mix it with the reflected light signal Rx. The mixer 312 may be configured to mix the reflected light signal Rx with the local oscillator signal LO. The mixer 312 may provide the mixed optical signal to differential photodetector 314, which may generate an electrical signal representing the beat frequency f_{beat} of the mixed optical signals, where f_{beat}=|f_{Tx2}−f_{Rx}| (the absolute value of the difference between the frequencies of the mixed optical signals). In some embodiments, the current produced by the differential photodetector 314 based on the mixed light may have the same frequency as the beat frequency f_{beat}. The current may be converted to a voltage by an amplifier (e.g., transimpedance amplifier (TIA)), which may be provided (e.g., fed) to an analog-to-digital converter (ADC) 316 configured to convert the analog voltage signal to digital samples for a target detection module 318. The target detection module 318 may be configured to determine (e.g., calculate) the radial velocity of the target 310 based on the digital sampled signal with the beat frequency f_{beat}.

In one example, the target detection module 318 may identify Doppler frequency shifts using the beat frequency f_{beat} and determine the radial velocity of the target 310 based on those shifts. For example, the radial velocity of the target 310 can be calculated using the following relationship:

$${f}_{d} = \frac{2}{λ} {v}_{t}$$

where, f_{d} is the Doppler frequency shift, λ is the wavelength of the laser signal, and vₜ is the radial velocity of the target 310. In some examples, the direction of the target 310 is indicated by the sign of the Doppler frequency shift fa. For example, a positive signed Doppler frequency shift may indicate that the target 310 is traveling towards the system 300 and a negative signed Doppler frequency shift may indicate that the target 310 is traveling away from the system 300.

In one example, a Fourier Transform calculation is performed using the digital samples from the ADC 316 to recover the desired frequency content (e.g., the Doppler frequency shift) from the digital sampled signal. For example, a controller (e.g., target detection module 318) may be configured to perform a Discrete Fourier Transform (DFT) on the digital samples. In certain examples, a Fast Fourier Transform (FFT) can be used to calculate the DFT on the digital samples. In some examples, the Fourier Transform calculation (e.g., DFT) can be performed iteratively on different groups of digital samples to generate a target point cloud.

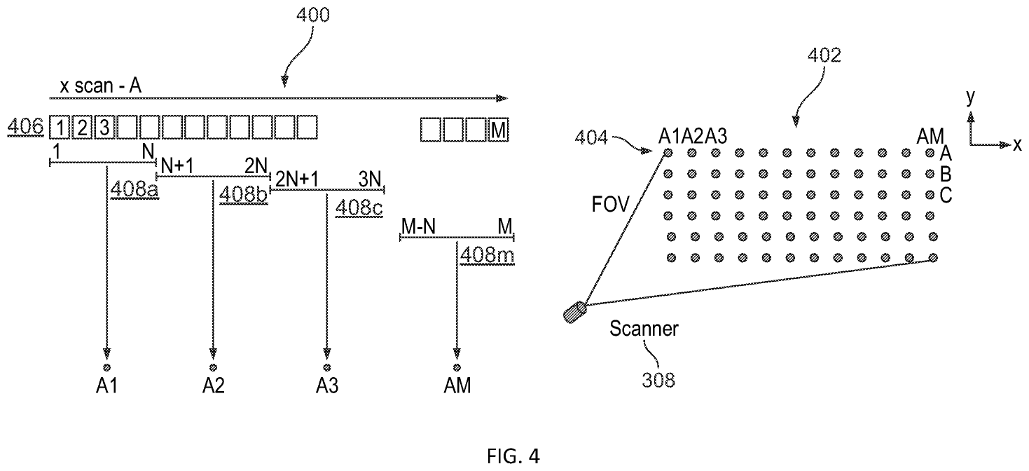

FIG. 4 illustrates a processing method 400 for generating a point cloud 402 over a field-of-view (FOV) of the lidar system 300. As shown, the point cloud 402 includes a two-dimensional array of points (e.g., A1, A2, etc.). In one example, the scanner 308 steers the transmitted laser signal over the FOV of the lidar system 300 to generate the point cloud 402. In some examples, the scanner 308 includes at least one mirror or prism configured to direct the laser signal in horizontal (e.g., x-axis) and vertical (e.g., y-axis) scan directions. In certain examples, portions of the lidar system 300 (including the scanner 308) can be rotated to steer the laser signal over the FOV. Some examples of lidar systems in which the CW coherent lidar system 300 and/or processing method 400 may be integrated are described below in the section titled “Some Examples of High-Resolution Continuous Wave (CW) Lidar Systems.”

As described above, a controller can perform a DFT on the samples collected by the lidar system 300 to generate the point cloud 402. In one example, the controller is configured to perform a DFT on groups of samples collected by the lidar system 300 while scanning in a horizontal direction (e.g., x-axis scan). For example, while the system 300 is scanning along a first row 404 of the point cloud 402, the controller can perform DFTs on an array of digital samples 406 provided from the ADC 316. The digital samples in the array 406 may be provided in chronological order as collected by the system 300 while scanning. As such, a first DFT can be performed (e.g., using an FFT algorithm) on a first group of samples 408a to generate a result that can be used to determine a first point A1 of the point cloud 402. Likewise, a second DFT can be performed (e.g., using an FFT algorithm) on a second group of samples 408b to generate a result that can be used to determine a second point A2 of the point cloud 402, a third DFT can be performed (e.g., using an FFT algorithm) on a third group of samples 408c to generate a result that can be used to determine a third point A3 of the point cloud 402, and so on. In the example of FIG. 4, the first group of samples 408a includes samples 1 to N, the second group of samples 408b includes samples from N+1 to 2N, the third group of samples 408c includes samples from 2N+1 to 3N, and so on.

While the digital samples can be processed in the groups 408 to generate measurement points (e.g., A1, A2, etc.), the resolution of the point cloud 402 may be limited by the size and/or composition of the groups 408. For example, the digital samples in the array 406 may be collected with a sampling frequency of 200 mega-samples per second (MS/s) with N having a value of 1024 samples. In such examples, the spacing of each point in time corresponds to 1024*1/200e6=5.12 μs. The lidar system 300 can be configured to operate with a horizontal scan rate of 10,000 degrees/second (deg/s), for example. At a scan rate of 10,000 deg/s, the horizontal resolution of the point cloud 402 may be limited to 10,000 deg/s*5.12 μs=51.2 mdeg.

In some lidar applications, it may be beneficial to provide high-resolution point cloud measurements (e.g., better than 51.2 mdeg). Attempting to reduce the size of the groups 408 (e.g., the DFT window size) to improve the resolution of the point cloud 402 may degrade the accuracy of the measurements. In other words, reducing the size of the groups 408 can degrade the frequency resolution of the DFT. However, in some examples, the groups 408 can be overlapped to improve the resolution of the point cloud 402 while maintaining measurement accuracy.

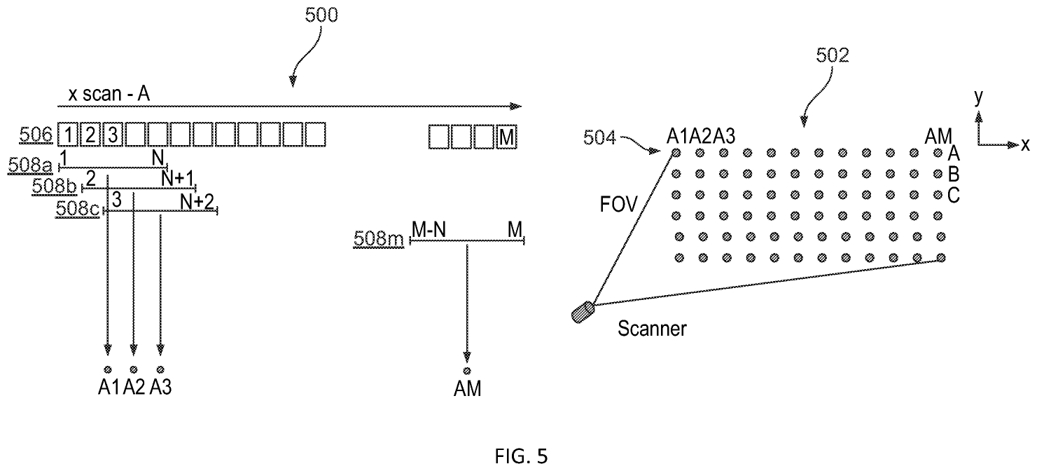

FIG. 5 illustrates a processing method 500 for generating a point cloud 502 over the FOV of the lidar system 300. In one example, the processing method 500 is substantially similar to the processing method 400 of FIG. 4, except the processing method 500 uses overlapping groups 508 rather than partitioned groups 408.

While the system 300 is scanning along a first row 504 of the point cloud 502, the controller can perform DFTs on an array of digital samples 506 provided from the ADC 316. The digital samples in the array 506 may be provided in chronological order as collected by the system 300 while scanning. As such, a first DFT can be performed (e.g., using an FFT algorithm) on a first group of samples 508a to generate a result that can be used to determine a first point A1 of the point cloud 502. Likewise, a second DFT can be performed (e.g., using an FFT algorithm) on a second group of samples 508b to generate a result that can be used to determine a second point A2 of the point cloud 502, a third DFT can be performed (e.g., using an FFT algorithm) on a third group of samples 508c to generate a result that can be used to determine a third point A3 of the point cloud 502, and so on. In one example, the overlapping groups 508 are equally sized and spaced at every ADC sample. For example, the first group of samples 508a includes samples 1 to N, the second group of samples 508b includes samples from 2 to N+1, the third group of samples 508c includes samples from 3 to N+2, and so on.

Similar to the example of FIG. 4, the digital samples in the array 506 may be collected with a sampling frequency of 200 MS/s with N having a value of 1024 samples, for example. Given that the overlapping groups 508 are spaced at every ADC sample, the spacing of the points in the point cloud 502 corresponds to the sampling resolution of the ADC 316 (i.e., the sampling frequency). For example, the spacing of each point in time corresponds to 1/200e6=5 ns. Assuming the lidar system 300 is operating with a horizontal scan rate of 10,000 deg/s, the processing method 500 can provide a point cloud 502 having a horizontal resolution of 10,000 deg/s*5 ns=0.05 mdeg.

As described above, the processing method 500 can be used to improve the resolution of the point cloud 502 while maintaining measurement accuracy. However, being that the overlapping groups 508 are spaced at every ADC sample, a new DFT calculation is performed for every ADC sample. In one example, each DFT calculation has a computation load (i.e., number of calculations) of N log(N). As such, performing DFT calculations for each ADC sample to generate the point cloud 502 can be computationally expensive in time and resources.

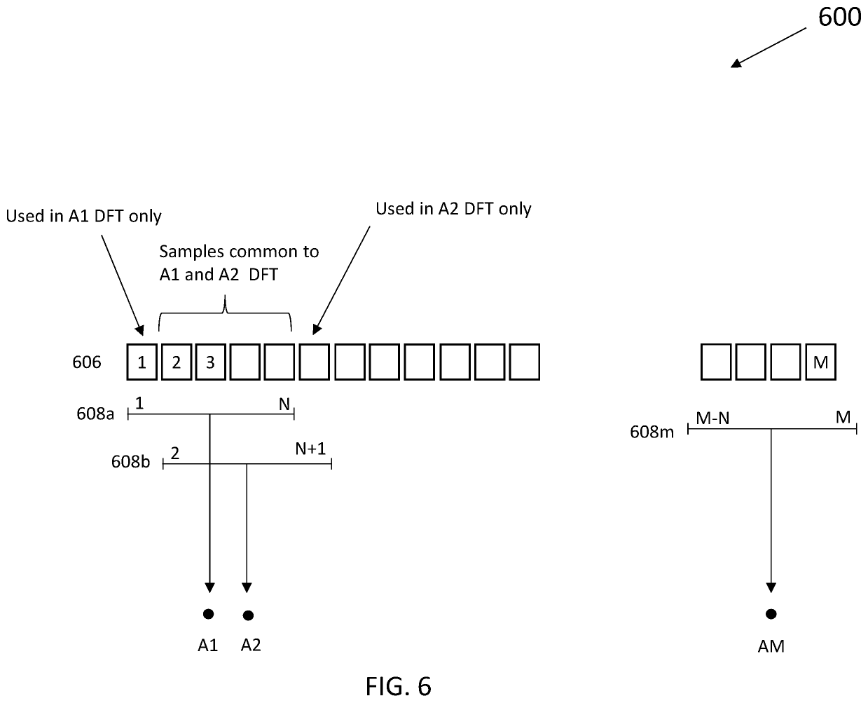

In one example, an incremental DFT process can be used to reduce the computational complexity of the processing method 500 by leveraging the configuration of the overlapping groups. For example, FIG. 6 illustrates a processing method 600 for generating the point cloud 502. The processing method 600 is substantially similar to the processing method 500, except only one full DFT calculation is performed in the processing method 600. In this context, “full DFT calculation” corresponds to the N log(N) calculations described above. While the system 300 is scanning along a first row 504 of the point cloud 502, the controller can process an array of digital samples 606 provided from the ADC 316. In one example, a full DFT calculation is performed (e.g., using an FFT algorithm) on the first group of samples 608a (e.g., 1 to N) to generate a result that can be used to determine the first point A1 of the point cloud 502. Rather than performing a full DFT calculation on the second group of samples 608b (e.g., 2 to N+1), the controller can re-use the result from the process of calculating A1 (“A1 FFT”) to generate the second point A2 of the point cloud 502. The re-use of the A1 FFT is based on the overlapping configuration of the first and second groups 608a, 608b. For example, rather than calculating the A2 FFT from scratch using the full DFT, a set of mathematical operations may be applied to the A1 FFT, the sample included in the first group 608a but not included in the second group 608b (e.g., first sample), and the sample included in the second group 608b but not included in the first group 608a (e.g., N+1 sample) to generate the A2 FFT. In some examples, the re-use of the A1 FFT (sometimes referred to herein as “the modification of the A1 FFT”) to produce the A2 FFT is represented by the following relationship:

$$FFT\_k ( A 2 ) = exp ( \frac{j 2 π k}{N} ) * [ FFT\_k ( A 1 ) - x ( 1 ) + x ( N + 1 ) ]$$

where N is the size of each group 608 (e.g., 1024 samples) and FFT_k(A1) is the kth frequency element of the A1 FFT. In one example, the A1 FFT is generated from the DFT performed on the first group of points 608a, x(1) is the first sample in the array 606, and x(N+1) is the N+1 sample in the array 606. A similar relationship can be used to determine the remaining points in the point cloud 502 (e.g., A3, A4, etc.). For example, the A2 FFT can be modified to produce the A3 FFT, the A3 FFT can be modified to produce the A4 FFT, and so on. In one example, the general relationship for modifying the kth FFT frequency points can be represented as:

$$FT\_k ( n ) = exp ( \frac{j 2 π k}{N} ) * [ FFT\_k ( n - 1 ) - x ( n - 1 ) + x ( N + n - 1 ) ] , \\ n = 2 , 3 , 4 , ...$$

where n is the current point cloud point (e.g., A3, A4, etc.) for which the FFT is being determined based on the FFT of the previous point cloud point n−1. As such, the process of modifying FFTs can be repeated for each overlapping group 608 across the first row 504 of the point cloud 502. In some examples, when the lidar system 300 scans to a new row of the point cloud 502 (e.g., the row below row 504), the process may start over. For example, when the system 300 starts a new row of the point cloud, the controller may perform a full DFT calculation on the first group of samples. Once the full DFT calculation is performed to generate a first point (e.g., B1), the controller can return to using the FFT modification process described above to generate the remaining points in the row (e.g., B2, B3, etc.). In some examples, the method 600 can reduce the computational complexity of processing the array of digital samples 606, allowing savings in time and resources to be realized.

While the lidar system 300 is described above as being configured to determine the radial velocity of a target, it should be appreciated that the system can be configured to determine the range and/or radial velocity of a target. For example, the lidar system 300 can be modified to use laser chirps to detect the velocity and/or range of a target.

Some examples have been described in which a DFT is used to generate points of a point cloud based on a group of samples. However, frequency analysis techniques (e.g., spectrum analysis techniques) other than the DFT may be used to generate points of a point cloud based on a group of samples. Any suitable frequency analysis technique may be used, including, without limitation, Discrete Cosine transform (DCT), Wavelet transform, Auto-Regressive moving average (ARMA), etc.

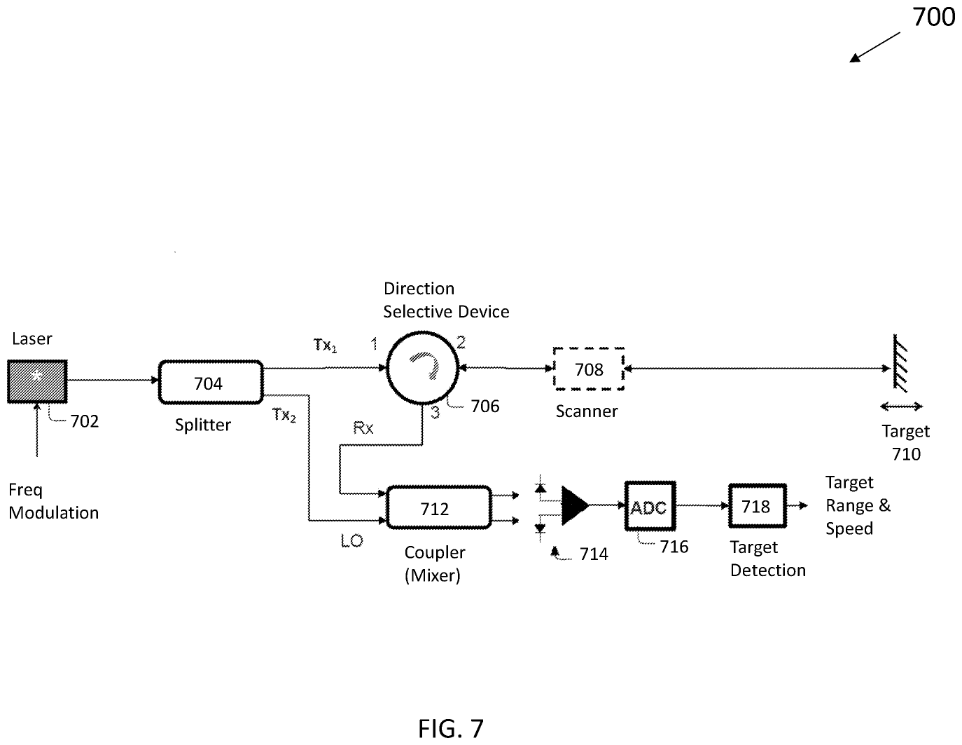

FIG. 7 illustrates an exemplary FMCW coherent lidar system 700 configured to determine the range and/or radial velocity of a target. Lidar system 700 includes a laser 702 configured to produce a laser signal which is fed into a splitter 704. The laser is “chirped” (e.g., the center frequency of the emitted laser beam is increased (“ramped up” or “chirped up”) or decreased (“ramped down” or “chirped down”) over time or, equivalently, the central wavelength of the emitted laser beam changes with time within a waveband). In various embodiments, the laser frequency is chirped quickly such that multiple phase angles are attained. In one example, the frequency of the laser signal is modulated by changing the laser operating parameters (e.g., current/voltage) or using a modulator included in the laser source 702; however, in other examples, an external modulator can be placed between the laser source 702 and the splitter 704.

In other examples, the laser frequency can be “chirped” by modulating the phase of the laser signal (or light) produced by the laser 702. In one example, the phase of the laser signal is modulated using an external modulator placed between the laser source 702 and the splitter 704; however, in some examples, the laser source 702 may be modulated directly by changing operating parameters (e.g., current/voltage) or include an internal modulator. Similar to frequency chirping, the phase of the laser signal can be increased (“ramped up”) or decreased (“ramped down”) over time.

Some examples of systems with FMCW-based lidar sensors have been described.

However, some embodiments of the techniques described herein may be implemented using any suitable type of lidar sensors including, without limitation, any suitable type of coherent lidar sensors (e.g., phase-modulated coherent lidar sensors). With phase-modulated coherent lidar sensors, rather than chirping the frequency of the light produced by the laser (as described above with reference to FMCW techniques), the lidar system may use a phase modulator placed between the laser 702 and the splitter 704 to generate a discrete phase modulated signal, which may be used to measure range and radial velocity.

As shown, the splitter 704 provides a first split laser signal Tx1 to a direction selective device 706, which provides (e.g., forwards) the signal Tx1 to a scanner 708. The scanner 708 uses the first laser signal Tx1 to transmit light emitted by the laser 702 and receives light reflected by the target 710. The reflected light signal Rx is provided (e.g., passed back) to the direction selective device 706. The second laser signal Tx2 and reflected light signal Rx are provided to a coupler (also referred to as a mixer) 712. The mixer may use the second laser signal Tx2 as a local oscillator (LO) signal and mix it with the reflected light signal Rx. The mixer 712 may be configured to mix the reflected light signal Rx with the local oscillator signal LO to generate a beat frequency f_{beat}. The mixed signal with beat frequency f_{beat} may be provided to a differential photodetector 714 configured to produce a current based on the received light. The current may be converted to a voltage by an amplifier (e.g., a transimpedance amplifier (TIA)), which may be provided (e.g., fed) to an analog-to-digital converter (ADC) 716 configured to convert the analog voltage to digital samples for a target detection module 718. The target detection module 718 may be configured to determine (e.g., calculate) the range and/or radial velocity of the target 710 based on the digital sample signal with beat frequency f_{beat}.

Laser chirping may be beneficial for range (distance) measurements of the target. In comparison, Doppler frequency measurements are generally used to measure target velocity. Resolution of distance can depend on the bandwidth size of the chirp frequency band such that greater bandwidth corresponds to finer resolution, according to the following relationships:

$$Range resolution : Δ R = \frac{c}{2 BW} ( given a perfectly linear chirp ) , and$$

$$Range : R = \frac{{f}_{beat} {cT}_{ChirpRamp}}{2 BW}$$

where c is the speed of light, BW is the bandwidth of the chirped laser signal, f_{beat} is the beat frequency, and TChirpRamp is the time period during which the frequency of the chirped laser ramps up (e.g., the time period corresponding to the up-ramp portion of the chirped laser). For example, for a distance resolution of 3.0 cm, a frequency bandwidth of 5.0 GHz may be used. A linear chirp can be an effective way to measure range and range accuracy can depend on the chirp linearity. In some instances, when chirping is used to measure target range, there may be range and velocity ambiguity. In particular, the reflected signal for measuring velocity (e.g., via Doppler) may affect the measurement of range. Therefore, some exemplary FMCW coherent lidar systems may rely on two measurements having different slopes (e.g., negative and positive slopes) to remove this ambiguity. The two measurements having different slopes may also be used to determine range and velocity measurements simultaneously.

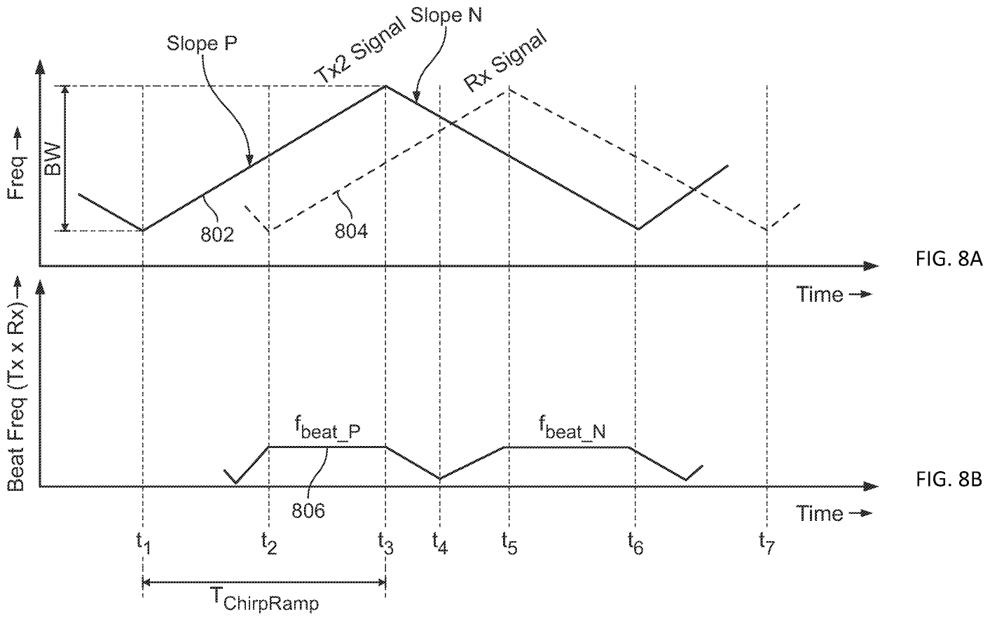

FIG. 8A is a plot of ideal (or desired) frequency chirp as a function of time in the transmitted laser signal Tx (e.g., signal Tx2), depicted in solid line 802, and reflected light signal Rx, depicted in dotted line 804. As depicted, the ideal Tx signal has a positive linear slope between time t1 and time t3 and a negative linear slope between time t3 and time t6. Accordingly, the ideal reflected light signal Rx returned with a time delay td of approximately t2-t1 has a positive linear slope between time t2 and time t5 and a negative linear slope between time t5 and time t7.

FIG. 8B is a plot illustrating the corresponding ideal beat frequency f_{beat 806} of the mixed signal Tx2×Rx. Note that the beat frequency f_{beat} 806 has a constant value between time t2 and time t3 (corresponding to the overlapping up-slopes of signals Tx2 and Rx) and between time t5 and time t6 (corresponding to the overlapping down-slopes of signals Tx2 and Rx).

The positive slope (“Slope P”) and the negative slope (“Slope N”) (also referred to as positive ramp (or up-ramp) and negative ramp (or down-ramp), respectively) can be used to determine the range and/or velocity. In some instances, referring to FIGS. 8A-8B, when the positive and negative ramp pair is used to measure range and velocity simultaneously, the following relationships are utilized:

$$Range : R = \frac{{cT}_{ChirpRamp} \frac{( {f}_{beat \_ P} + {f}_{beat \_ N} )}{2}}{2 BW} , and$$

$$Velocity : V = \frac{λ \frac{( {f}_{beat \_ P} - {f}_{beat \_ N} )}{2}}{2}$$

where f_{beat} p and f_{beat}_N are beat frequencies generated during positive (P) and negative (N) slopes of the chirp 802 respectively and A is the wavelength of the laser signal.

In one example, the scanner 708 of the lidar system 700 is used to scan the environment and generate a target point cloud from the acquired scan data. In some examples, the lidar system 700 can use processing methods that include performing one or more Fourier Transform calculations, such as a Fast Fourier Transform (FFT) or a Discrete Fourier Transform (DFT), to generate the target point cloud from the acquired scan data. Being that the system 700 is capable of measuring range, each point in the point cloud may have a three-dimensional location (e.g., x, y, and z) in addition to radial velocity. In some examples, the x-y location of each target point corresponds to a radial position of the target point relative to the scanner 708. Likewise, the z location of each target point corresponds to the distance between the target point and the scanner 708 (e.g., the range). In one example, each target point corresponds to one frequency chirp 802 in the laser signal. For example, the samples collected by the system 700 during the chirp 802 (e.g., t1 to t6) can be processed to generate one point in the point cloud.

### Some Examples of High-Resolution Continuous Wave (CW) Lidar Systems

In some examples, coherent lidar systems can include two lasers configured to provide separate frequency chirps in parallel to determine the range and/or speed (or velocity) of a target. In certain examples, the lasers may be configured to operate at different wavelengths with different rates of frequency movement.

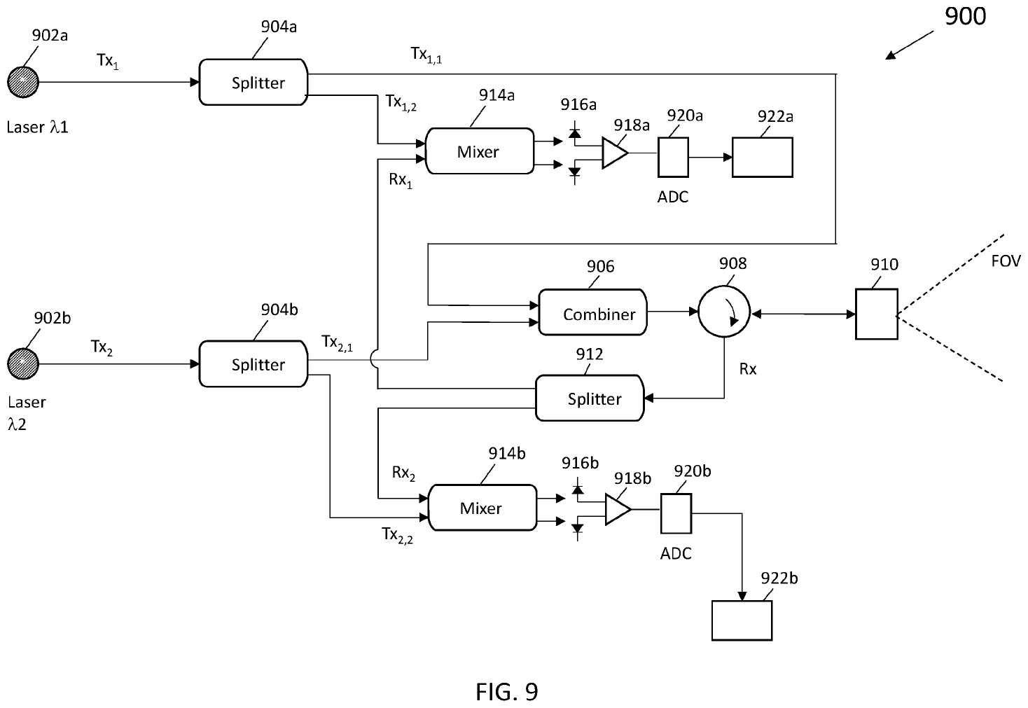

FIG. 9 illustrates an FMCW coherent lidar system 900 configured to determine the range and/or speed (or velocity) of a target in accordance with aspects described herein. The lidar system 900 includes a first laser 902a configured to produce a first laser signal Tx₁ having a first wavelength λ1 (e.g., 1530 nm). The first laser signal Tx₁ is provided to (e.g., fed into) a splitter 604a. The first laser signal Tx₁ is “chirped” such that the first laser frequency is changed with time over a frequency band BW1. In one example, the first laser frequency is changed at a first frequency rate α₁. The lidar system 900 includes a second laser 902b configured to produce a second laser signal Tx₂ having a second wavelength λ2 (e.g., 1550 nm). The second laser signal Tx₂ is fed into a splitter 904b. The second laser signal Tx₂ is “chirped” such that the second laser frequency is changed with time over a frequency band BW2. In one example, the second laser frequency is changed at a second frequency rate α₂. The frequency bands BW1 and BW2 may be non-overlapping. In some examples, BW1 and BW2 have values in the order of hundreds or thousands of GHz. In some examples, α₁ and α₂ have values in the order of 0.1-3 GHz/μs.

The splitter 904a provides a first split laser signal Tx_{1,1} generated from the first laser signal Tx to a combiner 906 and a second split laser signal Tx_{1,2} generated from the first laser signal Tx₁ to a first mixer 914a. Likewise, the splitter 904b provides a first split laser signal Tx_{2,1} generated from the second laser signal Tx₂ to the combiner 906 and a second split laser signal Tx_{2,2} generated from the second laser signal Tx₂ to a second mixer 914b. The combiner 906 combines the first split laser signals Tx_{1,1} and Tx2,1 and provides the combined signal to a direction selective device 908, which provides (e.g., forwards) the combined signal to a scanner 910. The scanner 910 uses the combined signal to transmit light and receives light reflected by a target. In one example, the scanner 910 steers the laser signal over the FOV of the lidar system 900. In some examples, the scanner 910 includes at least one mirror configured to direct the laser signal in horizontal (e.g., x-axis) and vertical (e.g., y-axis) scan directions. In certain examples, portions of the lidar system 900 (including the scanner 908) can be rotated to steer the laser signal over the FOV. In other examples, the scanner 910 can include a diffraction element (e.g., a prism) that directs light based on frequency. For example, as the frequencies of the signals provided by the first laser 902a and/or the second laser 902b are adjusted, the diffraction element may direct the light in different scan directions (e.g., similar to a scan mirror).

The reflected light signal Rx is provided (e.g., passed back) to the direction selective device 908, which provides (e.g., forwards) the reflected light signal Rx to a splitter 912. The splitter 912 provides a first split reflected light signal Rx₁ generated from the reflected light signal Rx to the first mixer 914a and a second split reflected light signal Rx₂ from the reflected light signal Rx to the second mixer 914b. In some examples, the splitter 912 includes one or more filters (e.g., band-pass filters) or functions as a wavelength division demultiplexing device to separate the two laser wavelengths. In certain examples, one or more filters can be used in place of the splitter 912. At the first mixer 914a, the second split laser signal Tx_{1,2} may be used as a local oscillator (LO) signal and mixed with the first split reflected light signal Rx₁. The first mixer 914a may be configured to mix the first split reflected light signal Rx₁ with the local oscillator signal LO to generate a beat frequency f_{b1}. The mixed signal with the beat frequency f_{b1} may be provided to a first differential photodetector 916a configured to produce a current based on the received light. In one example, the mixed signal is a single-ended signal; however, in other examples, the mixed signal can be a differential signal. The current may be converted to a voltage by an amplifier (e.g., a first transimpedance amplifier (TIA)) 918a, which may be provided to (e.g., fed to) a first analog-to-digital converter (ADC) 920a configured to convert the analog signal (e.g., voltage) to digital samples for a first target detection module 922a.

At the second mixer 914b, the second split laser signal Tx_{2,2} may be used as a local oscillator (LO) signal and mixed with the second split reflected light signal Rx₂. The second mixer 914b may be configured to mix the second split reflected light signal Rx₂ with the local oscillator signal LO to generate a beat frequency f_{b2}. The mixed signal with the beat frequency f_{b2} may be provided to a second differential photodetector 916b configured to produce a current based on the received light. In one example, the mixed signal is a single-ended signal; however, in other examples, the mixed signal can be a differential signal. The current may be converted to a voltage by a second amplifier (e.g., transimpedance amplifier (TIA)) 918b, which may be provided (e.g., fed) to a second analog-to-digital converter (ADC) 920b configured to convert the analog signal (e.g., voltage) to digital samples for a second target detection module 922b.

The target detection modules 922a, 922b may be configured to determine (e.g., calculate) the range and/or speed (or velocity) of the target based on the first digital sampled signal representing beat frequency f_{b1} and the second digital sampled signal representing beat frequency f_{b2}, as described in greater detail below. In some examples, the target detection modules 922a, 922b are configured to generate a point cloud corresponding to the FOV of the scanner 910. In one example, each of the target detection modules 922a, 922b corresponds to one or more controllers (or processors). In some examples, the target detection modules 922a, 922b correspond to the same controller (or processor).

In some examples, if the laser frequencies are spaced far enough apart, the lidar system can be arranged to share common components between the first laser and the second laser. For example, common components may be shared if inter-modulation products between the two lasers are out-of-band (e.g., outside component bandwidths or frequency bands of interest to the system). In other words, the spacing between the laser wavelengths may be selected such that the beating between the two laser frequencies is outside the electrical bandwidth of the electrical circuit that processes the electrical signal generated from the mixed optical signal. In some embodiments, the electrical circuit consists of photodiodes (e.g., a differential photodetector), a transimpedance amplifier, and an ADC. In one example, the electrical bandwidth of the lidar system is approximately 2 GHz. In other examples, the electrical bandwidth may be any value between approximately 500 MHz and 5 GHz.

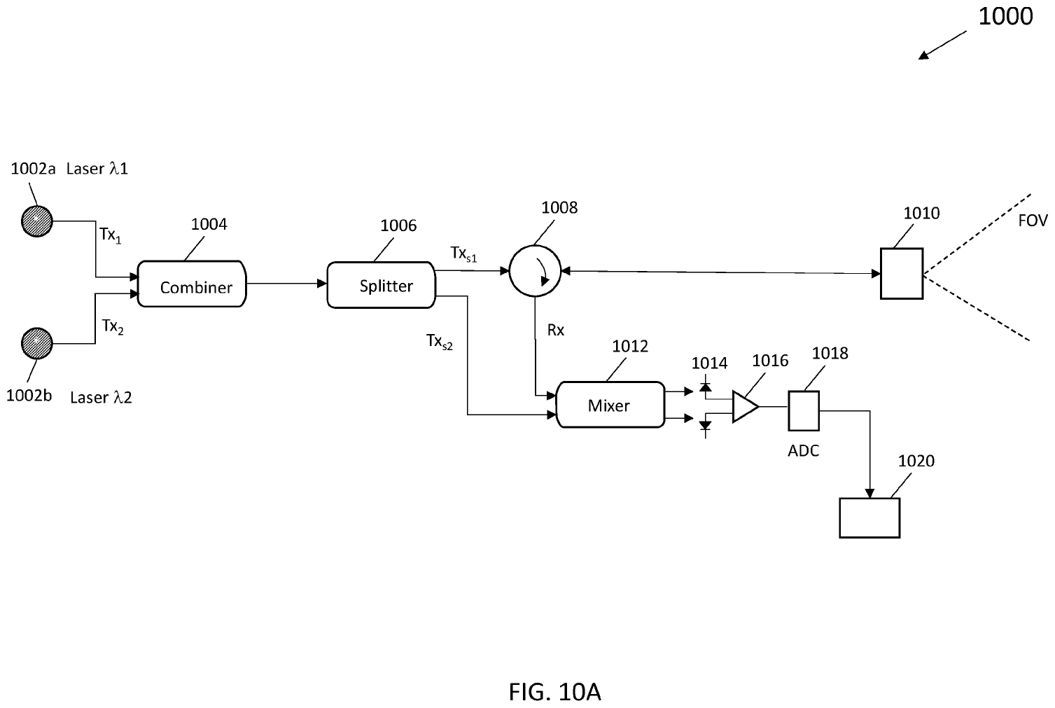

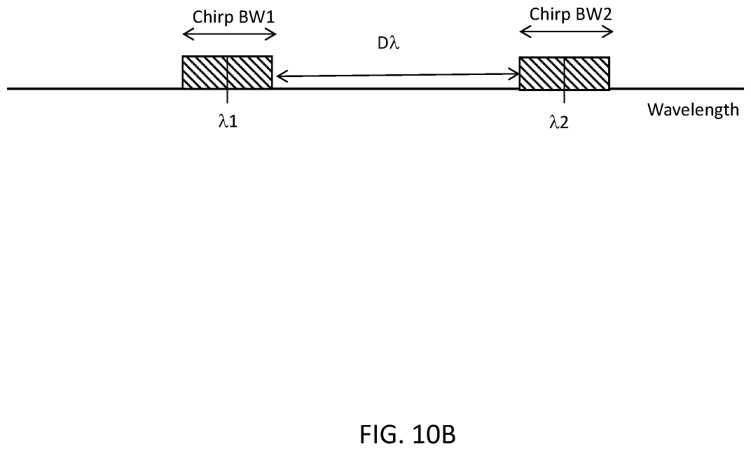

FIG. 10A illustrates an FMCW coherent lidar system 1000 configured to determine the range and/or speed (or velocity) of a target. In one example, the system 1000 includes one or more components shared between the multiple lasers. The lidar system 1000 includes a first laser 1002a configured to produce a first laser signal Tx₁ having a first wavelength λ1 (e.g., 1530 nm). The first laser signal Tx₁ is “chirped” such that the first laser frequency is changed with time over a frequency band. In one example, the first laser frequency is changed at a first frequency rate α₁. The lidar system 1000 includes a second laser 1002b configured to produce a second laser signal Tx₂ having a second wavelength λ2 (e.g., 1550 nm). The second laser signal Tx₂ is “chirped” such that the second laser frequency is changed with time over a frequency band. In one example, the second laser frequency is changed at a second frequency rate α₂.

A combiner 1004 combines the first laser signal Tx₁ and the second laser signal Tx₂ and provides the combined signal to a splitter 1006. The splitter 1006 provides a first split laser signal TXₛ₁ generated from the combined signal to direction selective device 1008, which provides (e.g., forwards) the first split laser signal TXₛ₁ to a scanner 1010. Likewise, the splitter 1006 provides a second split laser signal Txₛ₂ to a mixer 1012. The scanner 1010 uses the first split laser signal Txₛ₁ to transmit light and receives light reflected by a target. The scanner 1010 may be similar to the scanner 910 of FIG. 9. The reflected light signal Rx is provided (e.g., passed back) to the direction selective device 1008, which provides (e.g., forwards) the reflected light signal Rx to the mixer 1012.

At the mixer 1012, the second split laser signal Txₛ₂ is used as a local oscillator (LO) signal and mixed with the reflected light signal Rx. The mixer 1012 may be configured to mix the reflected light signal Rx with the local oscillator signal LO. The mixer 1012 may provide the mixed optical signal to the differential photodetector 1014, which may generate an electrical signal representing a first beat frequency f_{b1} of the mixed optical signals corresponding to the wavelength λ1 of the first laser 1002a and a second beat frequency f_{b2} of the mixed optical signals corresponding to the wavelength λ2 of the second laser 1002b. In one example, the first beat frequency f_{b1}=|fTₓ₁−f₁(Rx)| and the second beat frequency f_{b2}=|f_{Tx2}−f₂(Rx)| (the absolute values of the differences between the proximate frequency components of the mixed optical signal). In some embodiments, the current produced by the differential photodetector 1014 based on the mixed light may have frequency components at the first and second beat frequencies. In one example, the signal generated by the photodetector 1014 is a single-ended signal; however, in other examples, the signal generated by the photodetector 1014 can be a differential signal. The photodetector current may be converted to a voltage by an amplifier (e.g., a transimpedance amplifier (TIA)) 1016, and this voltage may be provided (e.g., fed) to an analog-to-digital converter (ADC) 1018 configured to convert the analog signal to digital samples for a target detection module 1020. The target detection module 1020 may be configured to determine (e.g., calculate) the range and/or radial velocity of the target based on the digital sampled signal with beat frequencies f_{b1} and f_{b2}.

The target detection module 1020 is configured to determine (e.g., calculate) the range and/or speed (or velocity) of the target based on the digital sampled signal with beat frequencies f_{b1}, f_{b2}, as described in greater detail below. In some examples, the target detection module 1020 is configured to generate a point cloud corresponding to the FOV of the scanner 1010. In one example, the target detection module 1020 corresponds to one or more controllers (or processors).

FIG. 10B illustrates a laser wavelength scheme that can be used with the lidar system 1000 of FIG. 10A. In one example, the first laser wavelength A1 corresponds to the wavelength of the first laser 1002a and the second laser wavelength λ2 corresponds to the wavelength of the second laser 1002b. As shown, a wavelength distance DA is provided based on the spacing of the wavelengths 21, 22. As described above, the lasers 1002a, 1002b can be chirped over wavelength (or frequency) to calculate the range and/or speed (or velocity) of the target. In some examples, the wavelength distance DA corresponds to the spacing between an upper edge of a first bandwidth BW1 associated with a chirp of the first laser 1002a and a lower edge of a second bandwidth BW2 associated with a chirp of the second laser 1002b. The bandwidths BW1, BW2 may have the same size or may be configured differently.

The spacing between the laser wavelengths (e.g., DA) may be selected such that the beat frequency (or frequencies) between the two laser wavelengths 21, 22 is outside the electrical bandwidth of the electrical circuit that processes the electrical signal generated from the mixed optical signal. In one embodiment, the electrical circuit consists of the differential photodetector 1014, the transimpedance amplifier 1016, and the ADC 1018. The spacing DA can be selected such that the two lasers 1002a, 1002b do not interact with each other directly. In one example, the following relationship can be used to select the spacing DA:

$$\vert D λ ( \frac{c}{{λ}^{2}} ) \vert ≫ {BW}_{sys}$$

where c is the speed of light, A is the wavelength A1 of the first laser 1002a or the wavelength 22 of the second laser 1002b, and BWsys is the electrical bandwidth of the lidar system 1000 (e.g., the bandwidth of the electrical circuit components included in the system).

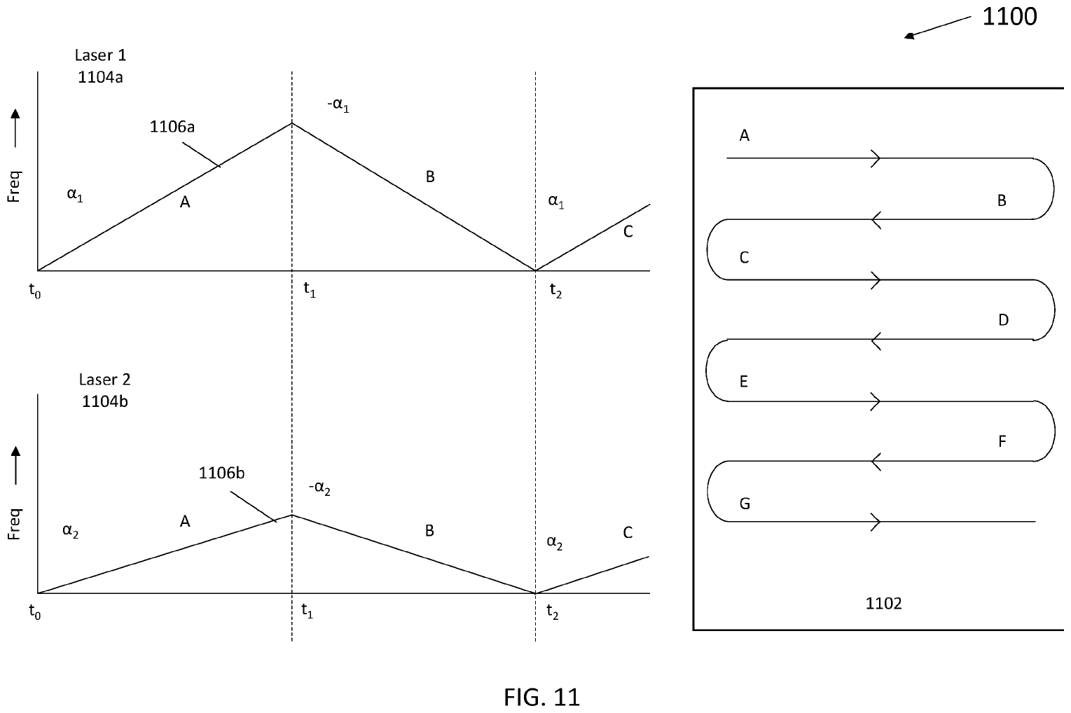

FIG. 11 illustrates a method 1100 for operating an FMCW coherent lidar system in accordance with aspects described herein. In one example, the method 1100 can be used to operate the lidar system 900 of FIG. 9 and/or the lidar system 1000 of FIG. 10. In the example of FIG. 11, the method 1100 involves the use of a scan pattern 1102 for generating a target point cloud. In some examples, the scan pattern 1102 corresponds to the scan direction of the scanner 910 (or the scanner 1010). In the illustrated example, the scan pattern 1102 includes scanning horizontally from left-to-right along a first row A, from right-to-left along a second row B, from left-to-right along a third row C, and so on.

A first graph 1104a illustrates a frequency chirp as a function of time for a first laser signal (e.g., first laser 902a, 1002a), depicted as solid line 1106a. Likewise, a second graph 1104b illustrates a frequency chirp as a function of time for a second laser signal (e.g., second laser 902b, 1002b), depicted as solid line 1106b. Rather than using chirps having a positive slope and a negative slope to generate each point of the point cloud, the chirps are configured with a unidirectional slope across each horizontal row of the scan pattern 1102. For example, the lidar system may scan along row A of the scan pattern 1102 from time to t₀ time t₁. During this first time period, the first laser provides a chirp 1106a having a positive slope that increases in frequency at the first frequency rate α₁. During the same time period, the second laser provides a chirp 1106b having a positive slope that increases in frequency at the second frequency rate α₂. In one example, the values of the first frequency rate di and the second frequency rate α₂ are between approximately 0.1-3 GHz/μs. Once the lidar system has completed the scan across row A, the system may scan along row B from time t₁ to time t2. During this second time period, the first laser may provide a chirp 1106a having a negative slope that decreases in frequency at the first frequency rate −α₁. During the same time period, the second laser provides a chirp 1106b having a negative slope that decreases in frequency at the second frequency rate −α₂. For the third scan across row C, the first and second lasers can return to providing chirps with positive slopes, and the process can repeat until the scan pattern 1102 is completed. Being that the chirps are configured with a unidirectional slope across each horizontal row of the scan pattern 1102, the scan rate of the lidar system is not limited by the chirp pattern. In other words, the lidar system does not have to wait for a particular chirp pattern to complete (e.g., slope up, slope down) before moving on to the next target point in the row.

An example has been described in which each scan line is scanned by simultaneously emitting two “long chirps” having different “slopes” (different rates of change in frequency). Such scanning is sufficiently robust to determine the range and velocity of the scanned points in a dynamic scene, where objects can be moving relative to the lidar sensor. However, when scanning a static scene (a scene in which objects are not moving relative to the lidar sensor), emission of a single long chirp 1106a (without simultaneous emission of a second long chirp 1106b) is sufficient to determine the range to each of the scan points on scan line A. In such cases, as described above, the range R to the each points can be calculated using the following expression:

$$R = \frac{{f}_{beat} {cT}_{ChirpRamp}}{2 BW}$$

Thus, in some embodiments, the lidar sensor may scan an environment (e.g., a static environment) to determine the ranges to points in the environment by emitting a sequence of individual long chirps 1106a. Each long chirp may correspond to a scan line or to any suitable portion of the scan pattern (e.g., a portion of a scan line).

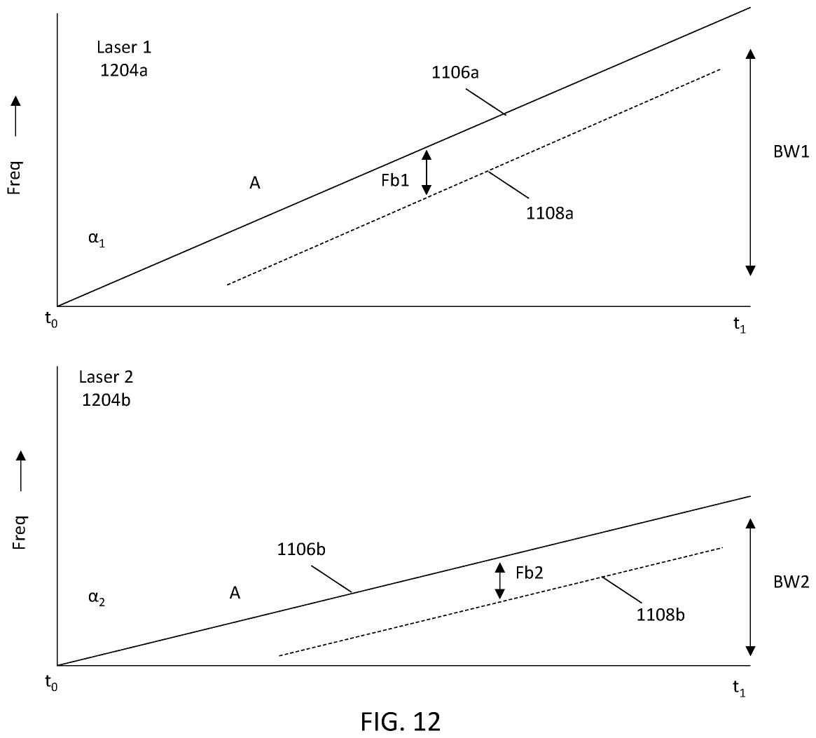

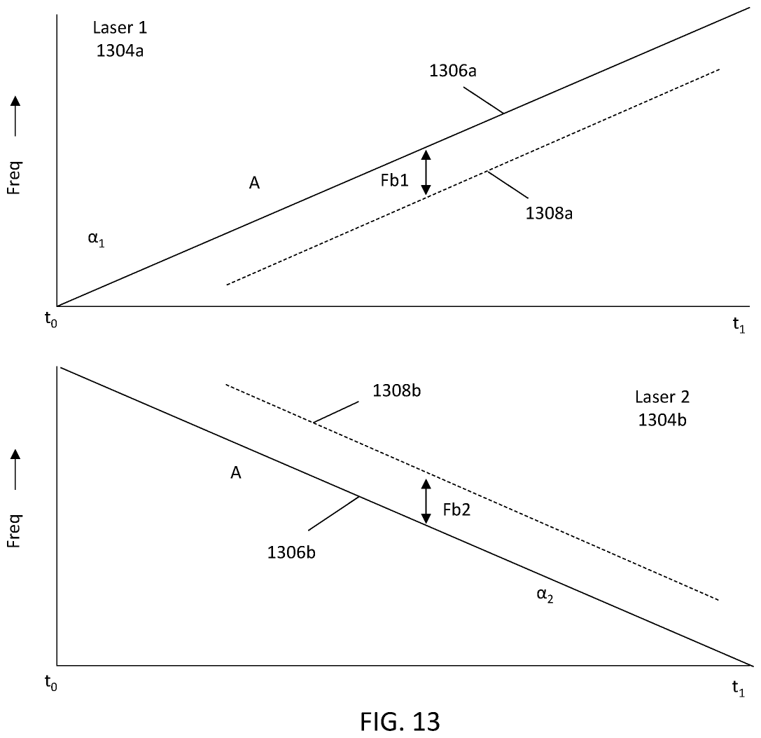

FIG. 12 includes a first graph 1204a representing a portion of the first chirp 1106a provided by the first laser and a second graph 1204b representing a portion of the second chirp 1106b provided by the second laser. As shown, the portions of the chirps 1106a, 1106b correspond to the first time period from time to t₀ time t₁ while the lidar system is scanning along row A of the scan pattern 1102. In one example, the first frequency rate α₁ is greater than the second frequency rate α₂. As such, the frequency of the first chirp 1106a increases at a faster rate than the frequency of the second chirp 1106b. In some examples, being that the first frequency rate α₁ is greater than the second frequency rate α₂, the bandwidth BW1 of the first chirp 1106a is larger than the bandwidth BW2 of the second chirp 1106b.

The first graph 1204a includes a first reflected signal 1108a corresponding to the chirp 1106a and the second graph 1204b includes a second reflected signal 1108b corresponding to the chirp 1106b. It should be appreciated that the reflected signals 1108a, 1108b can be received by the lidar system as a combined signal. In some examples, the combined signal is split into the reflected signals 1108a, 1108b via a splitter and/or one or more filters. As described above, the first reflected signal 1108a can be mixed with a local oscillator signal LO (e.g., the first chirp 1106a) to produce a first mixed signal representing a first beat frequency f_{b1}. Likewise, the second reflected signal 1108b can be mixed with a local oscillator signal LO (e.g., the second chirp 1106b) to produce a second mixed signal representing a second beat frequency f_{b2}. As shown, the first beat frequency f_{b1} may represent a difference between the first chirp 1106a and the first received signal 1108a and the second beat frequency f_{b2} may represent a difference between the second chirp 1106b and the second received signal 1108b.

In FIG. 12, the dashes in the lines 1108 may represent individual samples of the reflected signals 1108a and 1108b. In the example of FIG. 12, each of the samples of the reflected signal 1108a is illustrated as having the same beat frequency f_{b1} relative to the chirp 1106a, and each of the samples of the reflected signal 1108b is illustrated as having the same beat frequency f_{b2} relative to the chirp 1106b, which suggests that all of the samples were reflected by a single object at a uniform, unchanging distance from the lidar sensor (e.g., a stationary wall). It should be appreciated that, in general, each sample of the reflected signal 1108a may have a different beat frequency f_{b1} relative to the chirp 1106a, and each sample of the reflected signal 1108b may have a different beat frequency f_{b2} relative to the chirp 1106b. Such variation in the samples' beat frequencies would be expected, for example, when scanning an environment in which objects are located at different distances from the lidar sensor and/or in which objects are moving relative to the lidar sensor.

Once recovered, the beat frequencies f_{b1}, f_{b2} can be used to generate a point cloud by determining the range (and, optionally, speed or velocity) of the target. In some examples, the relationship between the beat frequencies, the range, and the velocity of the target corresponds to the slope of the chirps 1106a, 1106b. For example, in the positive slope case illustrated in FIG. 12, the following relationships can be used to determine the range and velocity of the target:

$${f}_{b 1} = {τα}_{1} - {f}_{d}$$

$${f}_{b 2} = {τα}_{2} - {f}_{d}$$

where t is the time of flight related to the range (R) to the target (e.g., t=2R/c) and fa is the Doppler frequency shift due to the radial velocity of the target. In one example, the relationships above assume that the frequency rates α₁, α₂ are greater than zero. Given that the beat frequencies f_{b1}, f_{b2} and the frequency rates α₁, α₂ are known, the system of equations can be solved to provide the following relationships:

$$τ = \frac{( {f}_{b 1} - {f}_{b 2} )}{( {α}_{1} - {α}_{2} )}$$

$${f}_{d} = \frac{( {f}_{b 1} - \frac{{α}_{1}}{{α}_{2}} {f}_{b 2} )}{( \frac{{α}_{1}}{{α}_{2}} - 1 )}$$

where t is the time of flight related to the range to the target and fa is the Doppler frequency shift due to the radial velocity of the target. As described above, the Doppler frequency can be used to calculate the velocity of the target. As such, the relationships above can be used to generate three-dimensional points for the point cloud while the chirps 1106a, 1106b have positive slopes (e.g., scan of Row A, scan of Row C, etc.).

For the negative slope case of the chirps 1106a, 1106b (e.g., scan of Row B), the following relationships can be used to determine the range and velocity of the target:

$${f}_{b 1} = {τα}_{1} + {f}_{d}$$

$${f}_{b 2} = {τα}_{2} + {f}_{d}$$

where τ is the time of flight related to the range to the target and f_{d} is the Doppler frequency shift due to the radial velocity of the target. Given that the beat frequencies f_{b1}, f_{b2} and the frequency rates α₁, α₂ are known, the system of equations can be solved to determine the range (and, optionally, speed or velocity) of the target. As such, the relationships above can be used to generate three-dimensional points for the point cloud while the chirps 1106a, 1106b have negative slopes.

While the examples above describe operating the lidar systems 900, 1000 with first and second lasers configured to provide chirps 1106a, 1106b with the same slope direction, it should be appreciated that the chirps 1106a, 1106b can be configured differently.

FIG. 13 includes a first graph 1304a representing a portion of a first chirp 1306a provided by the first laser and a second graph 1304b representing a portion of the second chirp 1306b provided by the second laser. As shown, the portions of the chirps 1306a, 1306b correspond to the first time period from time to t₀ time t₁ while the lidar system is scanning along row A of the scan pattern 1102. In one example, the first frequency rate α₁ is substantially the same as the second frequency rate α₂, except the first frequency rate α₁ and the second frequency rate α₂ have opposite signs. As such, the frequency of the first chirp 1306a increases over the first period and the frequency of the second chirp 1306b decreases over the first time period at the same rate. In some examples, the bandwidth of the first chirp 1306a is substantially the same as bandwidth of the second chirp 1306b.

The first graph 1304a includes a first reflected signal 1308a corresponding to the chirp 1306a and the second graph 1304b includes a second reflected signal 1308b corresponding to the chirp 1306b. It should be appreciated that the reflected signals 1308a, 1308b can be received by the lidar system as a combined signal. In some examples, the combined signal is split into the reflected signals 1308a, 1308b via a splitter and/or one or more filters. As described above, the first reflected signal 1308a can be mixed with a local oscillator signal LO (e.g., the first chirp 1306a) to produce a first mixed signal representing a first beat frequency f_{b1}. Likewise, the second reflected signal 1308b can be mixed with a local oscillator signal LO (e.g., the second chirp 1306b) to produce a second mixed signal representing a second beat frequency f_{b2}. As shown, the first beat frequency f_{b1} may represent a difference between the first chirp 1306a and the first received signal 1308a and the second beat frequency f_{b2} may represent a difference between the second chirp 1306b and the second received signal 1308b.

Once recovered, the beat frequencies f_{b1}, f_{b2} can be used to generate a point cloud by determining the range (and, optionally, speed or velocity) of the target. For example, in the case illustrated in FIG. 13, the following relationships can be used to determine the range and velocity of the target:

$${f}_{b 1} = {τα}_{1} - {f}_{d}$$

$${f}_{b 2} = {τα}_{2} + {f}_{d}$$

where t is the time of flight related to the range to the target and fa is the Doppler frequency shift due to the radial velocity of the target. In one example, the relationships above assume that the frequency rates α₁, α₂ are non-zero. Given that the beat frequencies f_{b1}, f_{b2} and the frequency rates α₁, α₂ are known, the system of equations can be solved to provide the following relationships:

$$τ = \frac{( {f}_{b 1} + {f}_{b 2} )}{( {α}_{1} + {α}_{2} )}$$

$${f}_{d} = \frac{( \frac{{α}_{1}}{{α}_{2}} {f}_{b 2} - {f}_{b 1} )}{( \frac{{α}_{1}}{{α}_{2}} + 1 )}$$

where τ is the time of flight related to the range to the target and fa is the Doppler frequency shift due to the radial velocity of the target. As described above, the Doppler frequency can be used to calculate the velocity (or speed) of the target. As such, the relationships above can be used to generate three-dimensional points for the point cloud.

In FIG. 13, the dashes in the lines 1308 may represent individual samples of the reflected signals 1308a and 1308b. In the example of FIG. 13, each of the samples of the reflected signal 1308a is illustrated as having the same beat frequency f_{b1} relative to the chirp 1306a, and each of the samples of the reflected signal 1308b is illustrated as having the same beat frequency f_{b2} relative to the chirp 1306b, which suggests that all of the samples were reflected by a single object at a uniform, unchanging distance from the lidar sensor (e.g., a stationary wall). It should be appreciated that, in general, each sample of the reflected signal 1308a may have a different beat frequency f_{b1} relative to the chirp 1306a, and each sample of the reflected signal 1308b may have a different beat frequency f_{b2} relative to the chirp 1306b. Such variation in the samples' beat frequencies would be expected, for example, when scanning an environment in which objects are located at different distances from the lidar sensor and/or in which objects are moving relative to the lidar sensor.

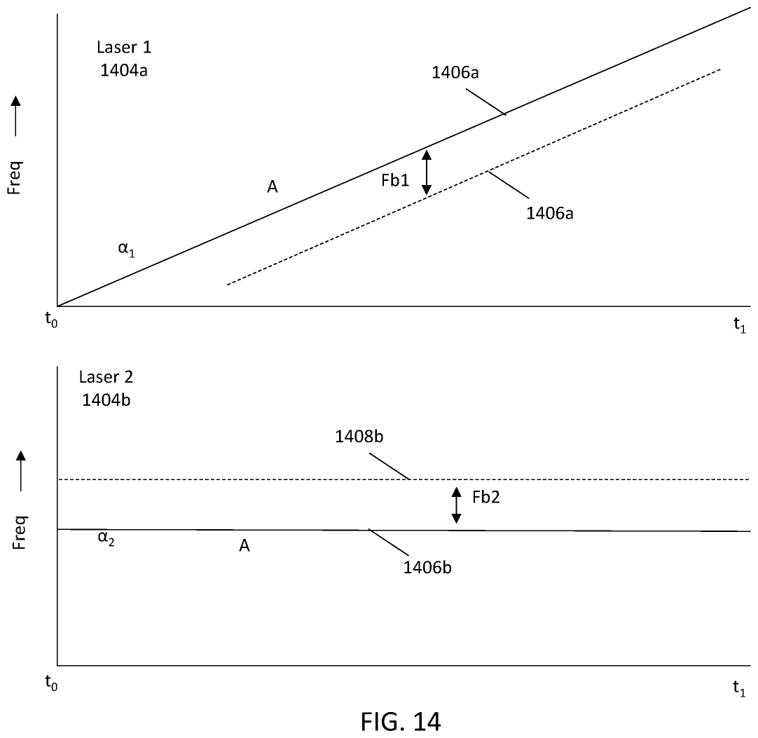

FIG. 14 includes a first graph 1404a representing a portion of a first chirp 1406a provided by the first laser and a second graph 1404b representing a portion of the second chirp 1406b provided by the second laser. As shown, the portions of the chirps 1406a, 1406b correspond to the first time period from time to t₀ time t₁ while the lidar system is scanning along row A of the scan pattern 1102. In one example, the first frequency rate α₁ is greater than zero and the second frequency rate α₂ is zero. As such, the frequency of the first chirp 1406a increases over the first period and the frequency of the second chirp 1406b remains substantially constant. In other examples, the first frequency rate α₁ may be zero and the second frequency rate α₂ may be greater than zero.

The first graph 1404a includes a first reflected signal 1408a corresponding to the chirp 1406a and the second graph 1404b includes a second reflected signal 1408b corresponding to the chirp 1406b. It should be appreciated that the reflected signals 1408a, 1408b can be received by the lidar system as a combined signal. In some examples, the combined signal is split into the reflected signals 1408a, 1408b via a splitter and/or one or more filters. As described above, the first reflected signal 1408a can be mixed with a local oscillator signal LO (e.g., the first chirp 1406a) to produce a first mixed signal representing a first beat frequency f_{b1}. Likewise, the second reflected signal 1408b can be mixed with a local oscillator signal LO (e.g., the second chirp 1406b) to produce a second mixed signal representing a second beat frequency f_{b2}. As shown, the first beat frequency f_{b1} may represent a difference between the first chirp 1406a and the first received signal 1408a and the second beat frequency f_{b2} may represent a difference between the second chirp 1406b and the second received signal 1408b.

Once recovered, the beat frequencies f_{b1}, f_{b2} can be used to generate a point cloud by determining the range (and, optionally, speed or velocity) of the target. For example, in the case illustrated in FIG. 14, the following relationships can be used to determine the range and velocity of the target:

$$τ = \frac{( {f}_{b 1} + {f}_{d} )}{{α}_{1}}$$

$${f}_{d} = {f}_{b 2}$$

where τ is the time of flight related to the range to the target and f_{d} is the Doppler frequency shift due to the radial velocity of the target. As described above, the Doppler frequency shift can be used to calculate the velocity (or speed) of the target. As such, the relationships above can be used to generate three-dimensional points for the point cloud.

In one example, being that the second frequency rate α₂ is zero, the sign of the Doppler frequency may be undetectable using a non-phase diversity receiver (e.g., lidar systems 900, 1000). As such, a lidar system having a phase diversity receiver may be used with the chirp scheme of FIG. 14 to recover the sign (i.e., direction) of the Doppler frequency.

In FIG. 14, the dashes in the lines 1408 may represent individual samples of the reflected signals 1408a and 1408b. In the example of FIG. 14, each of the samples of the reflected signal 1408a is illustrated as having the same beat frequency f_{b1} relative to the chirp 1406a, and each of the samples of the reflected signal 1408b is illustrated as having the same beat frequency f_{b2} relative to the chirp 1406b, which suggests that all of the samples were reflected by a single object at a uniform, unchanging distance from the lidar sensor (e.g., a stationary wall). It should be appreciated that, in general, each sample of the reflected signal 1408a may have a different beat frequency f_{b1} relative to the chirp 1406a, and each sample of the reflected signal 1408b may have a different beat frequency f_{b2} relative to the chirp 1406b. Such variation in the samples' beat frequencies would be expected, for example, when scanning an environment in which objects are located at different distances from the lidar sensor and/or in which objects are moving relative to the lidar sensor.

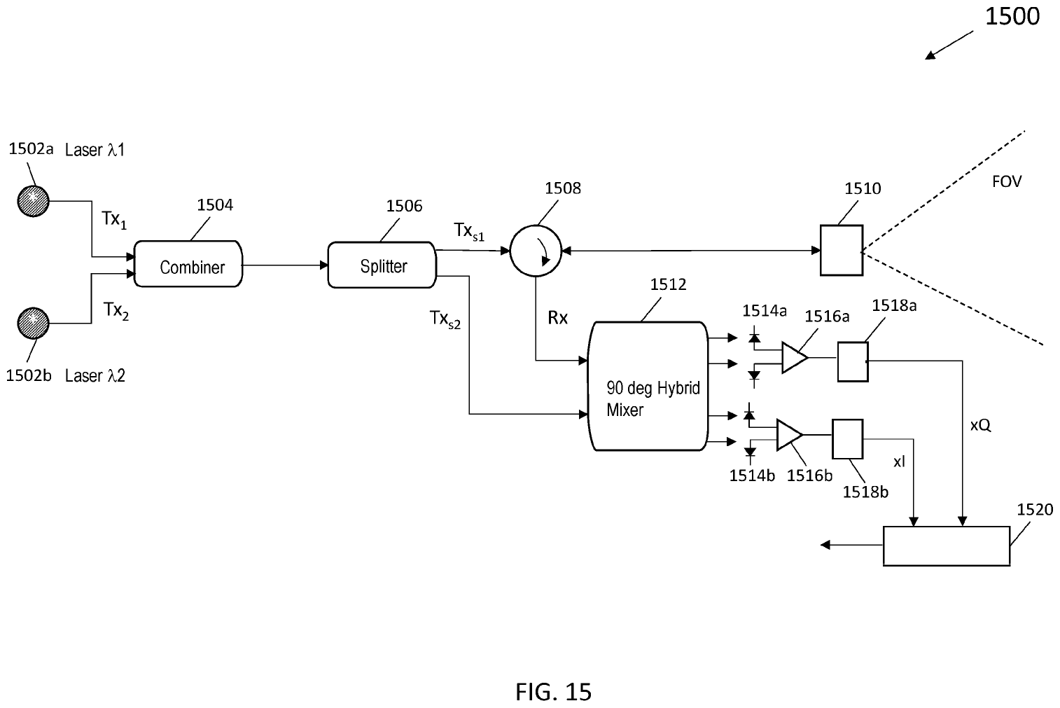

FIG. 15 illustrates an FMCW coherent lidar system 1500 configured to determine the range and/or speed of a target. In one example, the lidar system 1500 includes a phase diversity receiver. In some examples, the lidar system 1500 can operate with the chirp scheme illustrated in FIG. 14. The lidar system 1500 includes a first laser 1502a configured to produce a first laser signal Tx₁ having a first wavelength λ1 (e.g., 1530 nm). The first laser signal Tx₁ is “chirped” such that the first laser frequency is changed with time over a frequency band. In one example, the first laser frequency is changed at a first frequency rate α₁. The lidar system 1500 includes a second laser 1502b configured to produce a second laser signal Tx₂ having a second wavelength λ2 (e.g., 1550 nm). The second laser signal Tx₂ has a substantially constant laser frequency.

A combiner 1504 combines the first laser signal Tx₁ and the second laser signal Tx₂ and provides the combined signal to a splitter 1506. The splitter 1506 provides a first split laser signal TXₛ₁ from the combined signal to a direction selective device 1508, which forwards the first split laser signal TXₛ₁ to a scanner 1510. Likewise, the splitter 1506 provides a second split laser signal TXₛ₂ to a mixer 1512. In one example, the mixer 1512 is a 90 deg hybrid mixer. The scanner 1510 uses the first split laser signal Txₛ₁ to transmit light and receives light reflected by a target. The reflected light signal Rx is passed back to the direction selective device 1508, which provides (e.g., forwards) the reflected signal Rx to the mixer 1512.

At the mixer 1512, the second split laser signal Txₛ₂ is used as a local oscillator (LO) signal and mixed with the reflected signal Rx. The mixer 1512 is configured to mix the reflected signal Rx with the local oscillator signal LO. The mixer 1512 provides an in-phase (I) mixed optical signal to a first differential photodetector 1514a, which may generate an electrical signal representing a first beat frequency f_{b1} and a second beat frequency f_{b2} of the in-phase mixed optical signal. In one example, the first beat frequency f_{b1}=| f_{Tx1}−f_{1Rx}| and the second beat frequency f_{b2}=| f_{Tx2}−f_{2Rx}| (the absolute value of the difference between the proximate frequency components of the in-phase mixed optical signals). In some embodiments, a first current produced by the first differential photodetector 1514a based on the mixed light may have frequency components at the beat frequencies f_{b1}, f_{b2}. The first current is converted to a voltage by a first amplifier (e.g., transimpedance amplifier (TIA)) 1516a, and this voltage is provided (e.g., fed) to a first analog-to-digital converter (ADC) 1518a configured to convert the analog signal to digital samples for a target detection module 1520. Likewise, the mixer 1512 provides a 90 deg quadrature phase (Q) mixed optical signal to a second differential photodetector 1514b, which may generate an electrical signal representing the beat frequencies f_{b1}, f_{b2}. In some embodiments, a second current produced by the second differential photodetector 1514b based on the mixed light may have frequency components at the beat frequencies f_{b1}, f_{b2}. The second current is converted to a voltage by a second amplifier (e.g., TIA) 1516b, and this voltage is provided (e.g., fed) to a second ADC 1518b configured to convert the analog signal to digital samples for the target detection module 1520.

The target detection module 1520 may be configured to generate the range and/or speed of the target based on the digital sampled signals with beat frequencies f_{b1}, f_{b2}, as described above. In one example, a DFT is performed using the digital sampled signals. The sign (e.g., positive or negative) of the beat frequencies f_{b1}, f_{b2} may be used to determine the direction of the target Doppler shift. For example, a negative frequency may indicate that the target is moving away from the lidar system 1500. Likewise, a positive frequency may indicate that the target is moving towards the lidar system 1500. In one example, the signs of both beat frequencies f_{b1}, f_{b2} are used to determine the Doppler shift direction; however, in other examples, the Doppler shift direction may be determined from a single beat frequency (e.g., f_{b1} or f_{b2}). In some examples, the target detection module 1520 is configured to generate a point cloud corresponding to the FOV of the scanner 1510. In one example, the target detection module 1520 corresponds to one or more controllers (or processors).

### Additional Embodiments, Computing Devices, and Information Handling Systems

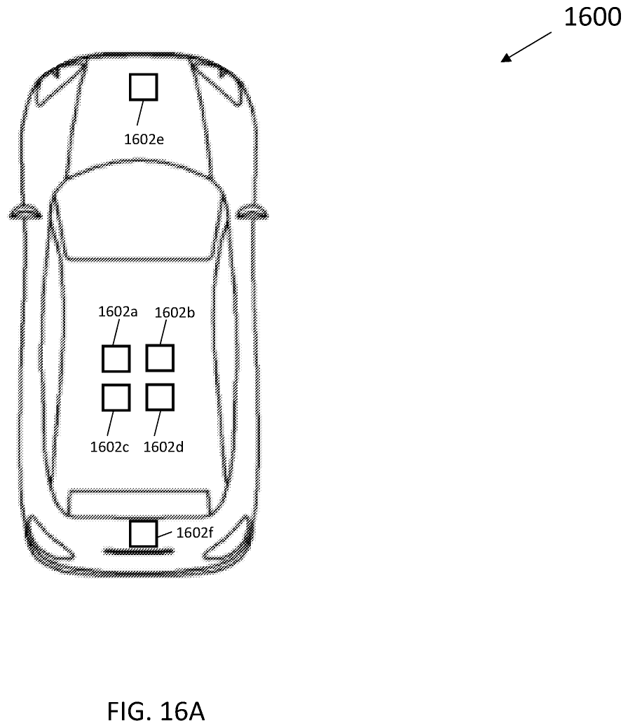

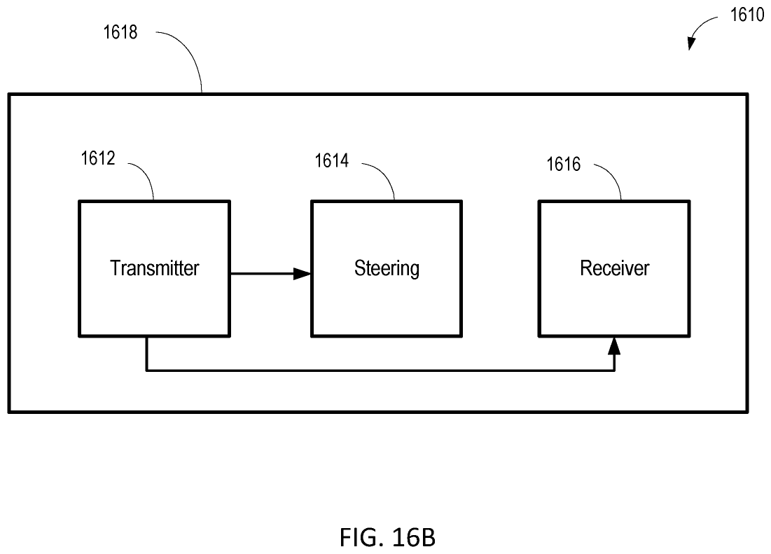

In some embodiments, lidar systems and techniques described herein may be used to provide mapping and/or autonomous navigation for a vehicle. FIG. 16A illustrates a vehicle 1600 having a plurality of sensors 1602. As shown, a first sensor 1602a, a second sensor 1602b, a third sensor 1602c, and a fourth sensor 1602d may be positioned in a first location on (or inside) the vehicle 1600 (e.g., the roof). Likewise, a fifth sensor 1602e may be positioned in a second location on (or inside) the vehicle 1600 (e.g., the front of the vehicle 1600) and a sixth sensor 1602f may be positioned in a third location on (or inside) the vehicle 1600 (e.g., the back of the vehicle 1600). In other examples, a different number or configuration of sensors may be used.

In some examples, at least one sensor of the plurality of sensors 1602 is configured to provide (or enable) 3-D mapping of the vehicle's surroundings. In certain examples, at least one sensor of the plurality of sensors 1602 is used to provide navigation for the vehicle 1600 within an environment. In one example, each sensor 1602 includes at least one lidar system, device, or chip. The lidar system(s) included in each sensor 1602 may correspond to the FMCW coherent lidar systems 900, 1000, and 1500 of FIGS. 9, 10A, and 15. In some examples, at least one sensor of the plurality of sensors 1602 may be a different type of sensor (e.g., camera, radar, etc.). In one example, the vehicle 1600 is a car; however, in other examples, the vehicle 1600 may be a truck, boat, plane, drone, vacuum cleaner (e.g., robot vacuum cleaner), robot, train, tractor, ATV, or any other type of vehicle or moveable object.

In some embodiments, lidar systems and techniques described herein may be implemented using Silicon photonics (SiP) technologies. SiP is a material platform from which photonic integrated circuits (PICs) can be produced. SiP is compatible with CMOS (electronic) fabrication techniques, which allows PICs to be manufactured using established foundry infrastructure. In PICs, light propagates through a patterned silicon optical medium that lies on top of an insulating material layer (e.g., silicon on Insulator (SOI)). In some cases, direct bandgap materials (e.g., indium phosphide (InP)) are used to create light (e.g., laser) sources that are integrated in an SiP chip (or wafer) to drive optical or photonic components within a photonic circuit. SiP technologies are increasingly used in optical datacom, sensing, biomedical, automotive, astronomy, aerospace, AR/VR, AI applications, navigation, identification imaging, drones, robotics, etc.

FIG. 16B is a block diagram of a silicon photonic integrated circuit (PIC) 1610 in accordance with aspects described herein. In one example, the lidar systems described herein can be implemented as the PIC 1610. The PIC 1610 includes a transmitter module 1612, a steering module 1614, and a receiver module 1616. As shown, the transmitter module 1612, the steering module 1614, and the receiver module 1006 are integrated on a silicon substrate 1618. In other examples, the transmitter module 1612, the steering module 1614, or the receiver module 1616 may be included on a separate substrate. In some embodiments, the steering module 1614 is used by the PIC 1610 in connection with transmission (e.g., emission) and reception (e.g., collection) of optical signals. In some examples, the silicon substrate 1618 includes a silicon layer (e.g., 200 nm-10 micron thickness) disposed over an oxide layer (e.g., approximately 2 micron thickness). In certain examples, the silicon substrate 1618 can include multiple silicon and/or oxide layers.

In one example, the transmitter module 1612 includes at least one laser source. In some examples, the laser source(s) are implemented using a direct bandgap material (e.g., InP) and integrated on the silicon substrate 1618 via hybrid integration. The transmitter module 1002 may also include at least one splitter, a combiner, and/or a direction selective device that are implemented on the silicon substrate 1618 via monolithic or hybrid integration. In some examples, the laser source(s) are external to the PIC 1610 and the laser signal(s) can be provided to the transmission module 1612.

In some embodiments, lidar systems and techniques described herein may be implemented using micro-electromechanical systems (MEMS). A MEMS is a miniature device that has both mechanical and electronic components. The physical dimension of a MEMS can range from several millimeters to less than one micrometer. Lidar systems may include one or more scanning mirrors implemented as a MEMS mirror (or an array of MEMS mirrors). Each MEMS mirror may be a single-axis MEMS mirror or dual-axis MEMS mirror. The MEMS mirror(s) may be electromagnetic mirrors. A control signal is provided to adjust the position of the mirror to direct light in at least one scan direction (e.g., horizontal and/or vertical). The MEMS mirror(s) can be positioned to steer light transmitted by the lidar system and/or to steer light received by the lidar system. MEMS mirrors are compact and may allow for smaller form-factor lidar systems, faster control speeds, and more precise light steering compared to other mechanical-scanning lidar methods. MEMS mirrors may be used in solid-state (e.g., stationary) lidar systems and rotating lidar systems.

In embodiments, aspects of the techniques described herein (e.g., timing the emission of the transmitted signal, processing received return signals, and so forth) may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), a network storage device, or any other suitable device and may vary in size, shape, performance, functionality, and price.

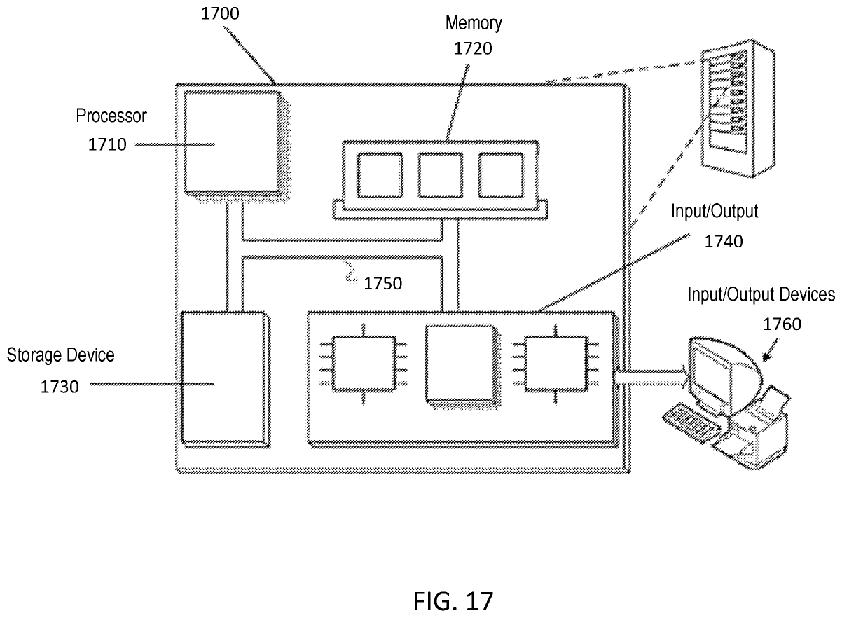

FIG. 17 is a block diagram of an example computer system 1700 that may be used in implementing the technology described in this document. General-purpose computers, network appliances, mobile devices, or other electronic systems may also include at least portions of the system 1700. The system 1700 includes a processor 1710, a memory 1720, a storage device 1730, and an input/output device 1740. Each of the components 1710, 1720, 1730, and 1740 may be interconnected, for example, using a system bus 1750. The processor 1710 is capable of processing instructions for execution within the system 1700. In some implementations, the processor 1710 is a single-threaded processor. In some implementations, the processor 1710 is a multi-threaded processor. In some implementations, the processor 1710 is a programmable (or reprogrammable) general purpose microprocessor or microcontroller. The processor 1710 is capable of processing instructions stored in the memory 1720 or on the storage device 1730.

The memory 1720 stores information within the system 1700. In some implementations, the memory 1720 is a non-transitory computer-readable medium. In some implementations, the memory 1720 is a volatile memory unit. In some implementations, the memory 1720 is a non-volatile memory unit.

The storage device 1730 is capable of providing mass storage for the system 1700. In some implementations, the storage device 1730 is a non-transitory computer-readable medium. In various different implementations, the storage device 1730 may include, for example, a hard disk device, an optical disk device, a solid-date drive, a flash drive, or some other large capacity storage devices. For example, the storage device may store long-term data (e.g., database data, file system data, etc.). The input/output device 1740 provides input/output operations for the system 1700. In some implementations, the input/output device 1740 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1730 may be implemented in a distributed way over a network, for example as a server farm or a set of widely distributed servers, or may be implemented in a single computing device.

Although an example processing system has been described in FIG. 17, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array), an ASIC (application specific integrated circuit), or a programmable general purpose microprocessor or microcontroller. A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA, an ASIC, or a programmable general purpose microprocessor or microcontroller.

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

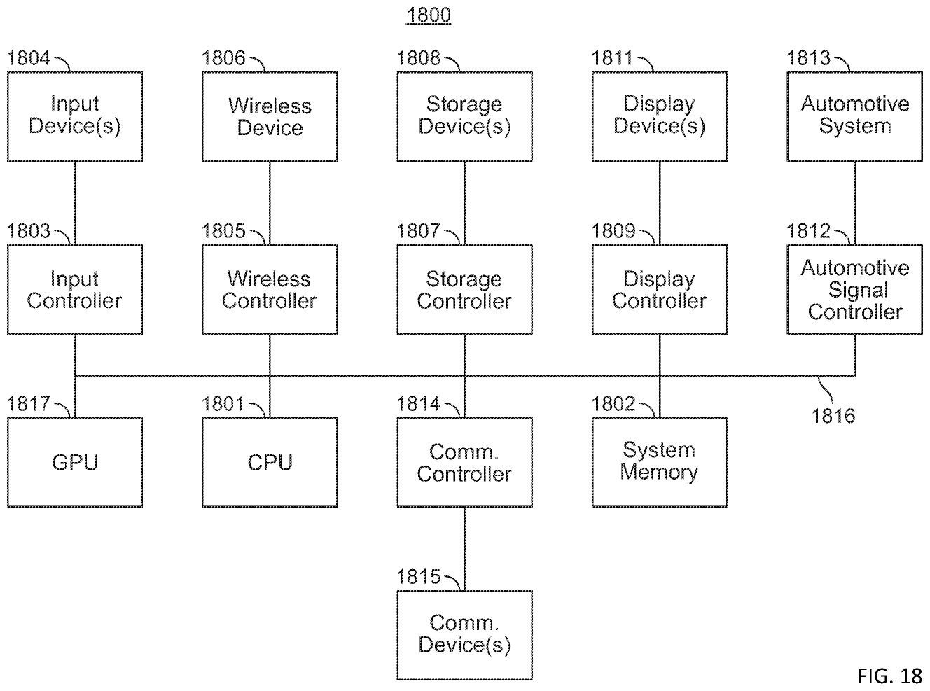

FIG. 18 depicts a simplified block diagram of a computing device/information handling system (or computing system) according to embodiments of the present disclosure. It will be understood that the functionalities shown for system 1800 may operate to support various embodiments of an information handling system—although it shall be understood that an information handling system may be differently configured and include different components.

As illustrated in FIG. 18, system 1800 includes one or more central processing units (CPU) 1801 that provide(s) computing resources and control(s) the computer. CPU 1801 may be implemented with a microprocessor or the like, and may also include one or more graphics processing units (GPU) 1817 and/or a floating point coprocessor for mathematical computations. System 1800 may also include a system memory 1802, which may be in the form of random-access memory (RAM), read-only memory (ROM), or both.

A number of controllers and peripheral devices may also be provided. For example, an input controller 1803 represents an interface to various input device(s) 1804, such as a keyboard, mouse, or stylus. There may also be a wireless controller 1805, which communicates with a wireless device 1806. System 1800 may also include a storage controller 1807 for interfacing with one or more storage devices 1808 each of which includes a storage medium such as magnetic tape or disk, or an optical medium that might be used to record programs of instructions for operating systems, utilities, and applications, which may include embodiments of programs that implement various aspects of the techniques described herein. Storage device(s) 1808 may also be used to store processed data or data to be processed in accordance with some embodiments. System 1800 may also include a display controller 1809 for providing an interface to a display device 1811, which may be a cathode ray tube (CRT), a thin film transistor (TFT) display, or other type of display. The computing system 1800 may also include an automotive signal controller 1812 for communicating with an automotive system 1813. A communications controller 1814 may interface with one or more communication devices 1815, which enables system 1800 to connect to remote devices through any of a variety of networks including the Internet, a cloud resource (e.g., an Ethernet cloud, an Fiber Channel over Ethernet (FCOE)/Data Center Bridging (DCB) cloud, etc.), a local area network (LAN), a wide area network (WAN), a storage area network (SAN), or through any suitable electromagnetic carrier signals including infrared signals.

In the illustrated system, all major system components may connect to a bus 1816, which may represent more than one physical bus. However, various system components may or may not be in physical proximity to one another. For example, input data and/or output data may be remotely transmitted from one physical location to another. In addition, programs that implement various aspects of some embodiments may be accessed from a remote location (e.g., a server) over a network. Such data and/or programs may be conveyed through any of a variety of machine-readable medium including, but not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Some embodiments may be encoded upon one or more non-transitory, computer-readable media with instructions for one or more processors or processing units to cause steps to be performed. It shall be noted that the one or more non-transitory, computer-readable media shall include volatile and non-volatile memory. It shall also be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or fabricate circuits (i.e., hardware) to perform the processing required.

It shall be noted that some embodiments may further relate to computer products with a non-transitory, tangible computer-readable medium that has computer code thereon for performing various computer-implemented operations. The medium and computer code may be those specially designed and constructed for the purposes of the techniques described herein, or they may be of the kind known or available to those having skill in the relevant arts. Examples of tangible, computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that is executed by a computer using an interpreter. Some embodiments may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the techniques described herein. One skilled in the art will also recognize that a number of the elements described above may be physically and/or functionally separated into sub-modules or combined together.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. A value of a feature may be a measurement of the corresponding property of an entity or an instance of information regarding an entity. Features can also have data types. For instance, a feature can have an image data type, a numerical data type, a text data type (e.g., a structured text data type or an unstructured (“free”) text data type), a categorical data type, or any other suitable data type. In general, a feature's data type is categorical if the set of values that can be assigned to the feature is finite.

As used herein, “model” may refer to any suitable model artifact generated by the process of using a machine learning algorithm to fit a model to a specific training data set. The terms “model,” “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

“Artificial intelligence” (AI) generally encompasses any technology that demonstrates intelligence. Applications (e.g., machine-executed software) that demonstrate intelligence may be referred to herein as “artificial intelligence applications,” “AI applications,” or “intelligent agents.” An intelligent agent may demonstrate intelligence, for example, by perceiving its environment, learning, and/or solving problems (e.g., taking actions or making decisions that increase the likelihood of achieving a defined goal). In many cases, intelligent agents are developed by organizations and deployed on network-connected computer systems so users within the organization can access them. Intelligent agents are used to guide decision-making and/or to control systems in a wide variety of fields and industries, e.g., security; transportation; risk assessment and management; supply chain logistics; and energy management. Intelligent agents may include or use models.

Some non-limiting examples of AI application types may include inference applications, comparison applications, and optimizer applications. Inference applications may include any intelligent agents that generate inferences (e.g., predictions, forecasts, etc.) about the values of one or more output variables based on the values of one or more input variables. In some examples, an inference application may provide a recommendation based on a generated inference. For example, an inference application for a lending organization may infer the likelihood that a loan applicant will default on repayment of a loan for a requested amount, and may recommend whether to approve a loan for the requested amount based on that inference. Comparison applications may include any intelligent agents that compare two or more possible scenarios. Each scenario may correspond to a set of potential values of one or more input variables over a period of time. For each scenario, an intelligent agent may generate one or more inferences (e.g., with respect to the values of one or more output variables) and/or recommendations. For example, a comparison application for a lending organization may display the organization's predicted revenue over a period of time if the organization approves loan applications if and only if the predicted risk of default is less than 20% (scenario #1), less than 10% (scenario #2), or less than 5% (scenario #3). Optimizer applications may include any intelligent agents that infer the optimum values of one or more variables of interest based on the values of one or more input variables. For example, an optimizer application for a lending organization may indicate the maximum loan amount that the organization would approve for a particular customer.

As used herein, “data analytics” may refer to the process of analyzing data (e.g., using machine learning models, artificial intelligence, models, or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

Data analytics tools are used to guide decision-making and/or to control systems in a wide variety of fields and industries, e.g., security; transportation; risk assessment and management; supply chain logistics; and energy management. The processes used to develop data analytics tools suitable for carrying out specific data analytics tasks generally include steps of data collection, data preparation, feature engineering, model generation, and/or model deployment.

As used herein, “spatial data” may refer to data relating to the location, shape, and/or geometry of one or more spatial objects. Data collected by lidar systems, devices, and chips described herein may be considered spatial data. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment). In some cases, a spatial object may be represented as a cluster of points in a 3-D point-cloud.

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

“Computer vision” generally refers to the use of computer systems to analyze and interpret image data. In some embodiments, computer vision may be used to analyze and interpret data collected by lidar systems (e.g., point-clouds). Computer vision tools generally use models that incorporate principles of geometry and/or physics. Such models may be trained to solve specific problems within the computer vision domain using machine learning techniques. For example, computer vision models may be trained to perform object recognition (recognizing instances of objects or object classes in images), identification (identifying an individual instance of an object in an image), detection (detecting specific types of objects or events in images), etc.

Computer vision tools (e.g., models, systems, etc.) may perform one or more of the following functions: image pre-processing, feature extraction, and detection/segmentation. Some examples of image pre-processing techniques include, without limitation, image re-sampling, noise reduction, contrast enhancement, and scaling (e.g., generating a scale space representation). Extracted features may be low-level (e.g., raw pixels, pixel intensities, pixel colors, gradients, patterns and textures (e.g., combinations of colors in close proximity), color histograms, motion vectors, edges, lines, corners, ridges, etc.), mid-level (e.g., shapes, surfaces, volumes, patterns, etc.), or high-level (e.g., objects, scenes, events, etc.). The detection/segmentation function may involve selection of a subset of the input image data (e.g., one or more images within a set of images, one or more regions within an image, etc.) for further processing.

### Some Embodiments

Some embodiments may include any of the following:

(A1) A lidar method includes transmitting, by a transmitter of a lidar sensor, a light signal into a portion of an environment along one direction within a time period, wherein the light signal changes within the time period over a frequency band at a particular frequency rate; receiving, by a receiver of the lidar sensor, a return signal corresponding to the light signal; and by a processor of the lidar sensor, generating a sequence of samples based on the light signal and the return signal, and generating a series of data points, in a point cloud, corresponding to a series of environmental points in the portion of the environment, wherein the data points are generated by performing a sliding discrete Fourier transform (DFT) on the sequence of samples, wherein each of the data points indicates a respective range to the corresponding environmental point.

(A2) The method of A1, wherein the light signal includes a chirp.

(A3) The method of any of A1-A2, wherein generating the sequence of samples includes determining, for each of the samples, a difference between a frequency of the light signal at a respective sample time and a frequency of the return signal at the respective sample time.

(A4) The method of any of A1-A3, wherein the data points include a first data point and a second data point adjacent to the first data point, the first data point is generated based on a first plurality of the samples, the second data point is generated based on a second plurality of the samples, and the first plurality of samples partially overlaps with the second plurality of samples.

(A5) The method of A4, wherein performing the sliding DFT on the sequence of samples includes performing a plurality of calculations on the first plurality of samples to generate the first data point; and reusing results of a subset of the calculations in combination with one or more additional calculations to generate the second data point.

(A6) The method of any of A1-A3, wherein performing the sliding DFT includes using a first sub-sequence of the sequence of samples to determine a first data point in the series of data points; and using a second sub-sequence of the sequence of samples to determine a second data point in the series of data points, wherein the second data point is adjacent to the first data point, and wherein the second sub-sequence of samples includes one or more samples from the first sub-sequence of samples.

(A7) A lidar method includes transmitting, by a transmitter of a lidar sensor, a first light signal and a second light signal into a first portion of an environment along a first direction within a first time period, wherein the first light signal changes within the first time period over a first frequency band at a first frequency rate, and wherein the second light signal changes within the first time period over a second frequency band at a second frequency rate; receiving, by a receiver of the lidar sensor, a first return signal corresponding to the first light signal and a second return signal corresponding to the second light signal; and by a processor of the lidar sensor, generating a sequence of samples based on the first light signal, the first return signal, the second light signal, and the second return signal, generating a series of data points, in a point cloud, corresponding to a series of environmental points in the portion of the environment, wherein the data points are generated by performing a sliding discrete Fourier transform (DFT) on the sequence of samples, wherein each of the data points indicates a respective range to the corresponding environmental point and/or a respective velocity of the corresponding environmental point.

(A8) The method of A7, wherein the first light signal includes a first chirp, and wherein the second light signal includes a second chirp.

(A9) The method of any of A7-A8, wherein generating the sequence of samples includes determining, for each of the samples, a difference between a frequency of the first light signal at a respective sample time and a frequency of the first return signal at the respective sample time; and determining, for each of the samples, a difference between a frequency of the second light signal at the respective sample time and a frequency of the second return signal at the respective sample time.

(A10) The method of any of A7-A9, wherein the data points include a first data point and a second data point adjacent to the first data point, the first data point is generated based on a first plurality of the samples, the second data point is generated based on a second plurality of the samples, and the first plurality of samples partially overlaps with the second plurality of samples.

(A11) The method of A10, wherein performing the sliding DFT on the sequence of samples includes performing a plurality of calculations on the first plurality of samples to generate the first data point; and reusing results of a subset of the calculations in combination with one or more additional calculations to generate the second data point.

(A12) The method of any of A7-A9, wherein performing the sliding DFT includes using a first sub-sequence of the sequence of samples to determine a first data point in the series of data points; and using a second sub-sequence of the sequence of samples to determine a second data point in the series of data points, wherein the second data point is adjacent to the first data point, and wherein the second sub-sequence of samples includes one or more samples from the first sub-sequence of samples.

(A13) A lidar device includes a first light source configured to emit a first light signal changing within a first time period over a first frequency band at a first frequency rate, and a second light source configured to emit a second light signal changing within the first time period over a second frequency band at a second frequency rate; a first light splitter configured to split the first light signal into a first split light signal directed into a scanner and a second split light signal directed into a first mixer, and a second light splitter configured to split the second light signal into a third split light signal directed into the scanner and a fourth split light signal directed into a second mixer; the scanner configured to direct the first split light signal into an environment and receive a first return signal returning from the environment, and direct the third split light signal into the environment and receive a second return signal returning from the environment, the first split light signal and the third split light signal being directed to a first portion of the environment along a first direction within the first time period; the first mixer configured to mix the second split light signal with the first return signal to generate a first mixed signal with a first beat frequency, and the second mixer configured to mix the fourth split light signal with the second return signal to generate a second mixed signal with a second beat frequency; and a processor configured to generate a first series of data points, in a point cloud, corresponding to a first series of environmental points in the first portion of the environment based on the first mixed signal with the first beat frequency and the second mixed signal with the second beat frequency, wherein each of the first series of data points includes a measurement of range and/or velocity of the first series of environment points scanned by the scanner within the first time period.

(A14) The lidar device of A13, wherein the first light source is further configured to emit a third light signal changing within a second time period over a third frequency band at a third frequency rate, and the second light source is further configured to emit a fourth light signal changing within the second time period over a fourth frequency band at a fourth frequency rate; the first light splitter is further configured to split the third light signal into a fifth split light signal directed into the scanner and a sixth split light signal directed into the first mixer, and the second light splitter is further configured to split the fourth light signal into a seventh split light signal directed into the scanner and a eighth split light signal directed into the second mixer; the scanner is further configured to direct the fifth split light signal into the environment and receive a third return signal returning from the environment, and direct the seventh split light signal into the environment and receive a fourth return signal returning from the environment, the fifth split light signal and the seventh split light signal being directed to a second portion of the environment along a second direction within the first time period, and the second direction being different from the first direction; the first mixer is further configured to mix the sixth split light signal with the third return signal to generate a third mixed signal with a third beat frequency, and the second mixer is further configured to mix the eighth split light signal with the fourth return signal to generate a fourth mixed signal with a fourth beat frequency; and the processor is further configured to generate a second series of data points, in the point cloud, corresponding to a second series of environmental points in the second portion of the environment based on the third mixed signal with the third beat frequency and the fourth mixed signal with the fourth beat frequency, wherein each of the second series of data points includes a measurement of range and/or velocity of the second series of environment points scanned by the scanner within the second time period.

(A15) The lidar device of any of A13-A14, wherein a first data point of the first series of data points is generated based on a first group of digital signals determined based on the first mixed signal and the second mixed signal and a second data point of the first series of data points is generated based on a second group of digital signals determined based on the first mixed signal and the second mixed signal, wherein the second group of digital signals include a subset of the first group of digital signals and at least one digital signal that is different from the first group of digital signals.

(A16) The lidar device of any of A13-A15, further including a combiner configured to combine the first split light signal and the third split light signal into a combined light signal directed into the scanner when directing the first split light signal and the third split light signal into the scanner.

(A17) The lidar device of A16, wherein the scanner is configured to direct the combined light signal into the environment when directing the first split light signal and the third split light signal into the environment, and receive a combined return signal from the environment when receiving the first return signal and the second return signal from the environment.

(A18) The lidar device of A17, further including a third splitter configured to split the combined return signal into the first return signal and the second return signal directed into the first mixer and the second mixer, respectively.

(A19) The lidar device of any of A13-A18, further including a first photodetector configured to produce a first analog signal based on the first mixed signal with the first beat frequency, and a second photodetector configured to produce a second analog signal based on the second mixed signal with the second beat frequency; and a first analog-to-digital converter configured to convert the first analog signal into a first set of digital signals, and a second analog-to-signal converter configured to convert the second analog signal into a second set of digital signals.

(A20) The lidar device of A19, wherein the processor is configured to determine the range and/or velocity of the first series of environment points based on the first set of digital signals and the second set of digital signals.

(A21) The lidar device of any of A13-A20, wherein the first frequency band and the second frequency band is non-overlapping.

(A22) The lidar device of A13-A14, wherein the first light signal emitted by the first light source changes over the first frequency band at a first positive slope during the first time period and at a first negative slope during the second time period, and the second light signal emitted by the second light source changes over the second frequency band at a second positive slope during the first time period and at a second negative slope during the second time period.

(A23) The lidar device of any of A13-A14, wherein the first light signal emitted by the first light source changes over the first frequency band at a first positive slope during the first time period and at a first negative slope during the second time period, and the second light signal emitted by the second light source changes over the second frequency band at a second negative slope during the first time period and at a second positive slope during the second time period.

(A24) The lidar device of any of A13-A14, wherein one of the first frequency rate and the second frequency rate is zero, and the other one of the first frequency rate and the second frequency rate is non-zero.

(A25) A lidar device includes a first light source configured to emit a first light signal changing within a first time period at a first frequency rate over a first frequency band, and a second light source configured to emit a second light signal changing within the first time period at a second frequency rate over a second frequency band; a combiner configured to combine the first light signal and the second light signal to generate a first combined light signal; a splitter configured to split the first combined light signal into a first split light signal and a second split light signal; a scanner configured to direct the first split light signal into an environment, and receive a first return light signal returning from the environment, the first split light signal being directed to a first portion of the environment along a first direction; a mixer configured to mix the first return light signal and the second split light signal to generate a first mixed signal with a first beat frequency corresponding to the first light signal and a second beat frequency corresponding to the second light signal; and a processor configured to generate a first series of data points, in a point cloud, corresponding to a first series of environmental points in the first portion of the environment based on the first mixed signal with the first beat frequency and the second beat frequency, wherein each of the first series of data points includes a measurement of range and/or velocity of the first series of environment points scanned by the scanner within the first time period.

(A26) The lidar device of A25, wherein the first light source is further configured to a third light signal changing within a second time period over a third frequency band at a third frequency rate, and the second light source is further configured to emit a fourth light signal changing within the second time period over a fourth frequency band at a fourth frequency rate; the combiner is further configured to combine the third light signal and the fourth light signal to generate a second combined light signal; the splitter is further configured to split the second combined light signal into a third split light signal and a fourth split light signal; the scanner is further configured to direct the third split light signal into the environment, and receive a second return light signal returning from the environment, the third split light signal being directed to a second portion of the environment along a second direction, and the second direction being different from the first direction; the mixer is further configured to mix the second return light signal and the fourth split light signal to generate a second mixed signal with a third beat frequency corresponding to the third light signal and a fourth beat frequency corresponding to the fourth light signal; and the processor is further configured to generate a second series of data points corresponding to a second series of environmental points in the second portion of the environment based on the second mixed signal with the third beat frequency and the fourth beat frequency, wherein each of the second series of data points includes a measurement of range and/or velocity of the second series of environment points scanned by the scanner within the second time period.

(A27) The lidar device of any of A25-A26, wherein a first data point of the first series of data points is generated based on a first group of digital signals determined based on the first mixed signal and a second data point of the first series of data points is generated based on a second group of digital signals determined based on the first mixed signal, wherein the second group of digital signals include a subset of the first group of digital signals and at least one digital signal that is different from the first group of digital signals.

(A28) The lidar device of any of A25-A27, further including a photodetector configured to produce a current based on the mixed signal with the first beat frequency and the second beat frequency; an amplifier configured to convert the current into a voltage; and an analog-to-digital converter configured to convert the voltage into a set of digital signals.

(A29) The lidar device of A28, wherein the processor is configured to determine the range and/or velocity of the first series of environment points based on the set of digital signals.

(A30) The lidar device of any of A25-A29, wherein a wavelength difference between a first wavelength corresponding to the first light signal and a second wavelength corresponding to the second light signal corresponds to an upper edge of the first frequency bandwidth and a lower edge of the second frequency bandwidth.

(A31) The lidar device of A30, wherein the mixer is a hybrid mixer configured to generate an in-phase mixed signal with the first beat frequency and the second beat frequency and an quadrature phase mixed signal with the first beat frequency and the second beat frequency.

(A32) The lidar device of A31, further including a first photodetector configured to generate a first current based on the in-phase mixed signal, and a second photodetector configured to generate a second current based on the quadrature phase mixed signal; a first amplifier configured to convert the first current into a first voltage, and a second amplifier configured to convert the second current into the second voltage; and a first analog-to-digital converter configured to convert the first voltage into a first set of digital signals, and a second analog-to-signal converter configured to convert the second voltage into a second set of digital signals.

(A33) The lidar device of A32, wherein the processor is configured to determine the range and/or velocity of the first series of environment points based on the first set of digital signals and the second set of digital signals.

(A34) A method for operating a lidar device includes providing, via a first light source, a first light signal changing within a first time period over a first frequency band at a first frequency rate, and providing, via a second light source, a second light signal changing within the first time period over a second frequency band at a second frequency rate; splitting, via a first splitter, the first light signal into a first split light signal, directed into an environment via a scanner, and a second split light signal directed into a first mixer, and splitting, via a second splitter, the second light signal into a third split light signal, directed into the environment via the scanner, and a fourth split light signal directed into a second mixer, the first split light signal and the third split light signal being directed towards a portion of the environment along a first direction; receiving, via the scanner, a first return signal corresponding to the first split light signal and a second return signal corresponding to the third split light signal; mixing, via the first mixer, the second split light signal with the first return signal to generate a first mixed signal with a first beat frequency, and mixing, via the second mixer, the fourth split light signal with the second return signal to generate a second mixed signal with a second beat frequency; and determining, by a processor, a series of data points, in a point cloud, corresponding to a series of environmental points in the portion of the environment based on the first mixed signal with the first beat frequency and the second mixed signal with the second beat frequency, wherein each of the series of data points includes a measurement of range and/or velocity of the series of environment points scanned by the scanner within the first time period.

(A35) A method for operating a lidar device includes providing, via a first light source, a first light signal changing within a first time period over a first frequency band at a first frequency rate, and providing, via a second light source, a second light signal changing within the first time period over a second frequency band at a second frequency rate; combining, via a combiner, the first light signal and the second light signal to generate a combined light signal; splitting, via a splitter, the combined light signal into a first split light signal and a second split light signal; directing, via a scanner, the first split light signal into an environment, and receiving, via the scanner, a return light signal returning from the environment, the first split light signal being directed to a portion of the environment along a first direction; mixing, via a mixer, the return light signal with the second split light signal to generate a mixed signal with a first beat frequency corresponding to the first light signal and a second beat frequency corresponding to the second light signal; and determining, by a processor, a series of data points, in a point cloud, corresponding to a series of environmental points in the portion of the environment based on the mixed signal with the first beat frequency and the second beat frequency, wherein each of the series of data points includes a measurement of range and/or velocity of the series of environment points scanned by the scanner within the first time period.

### Terminology

The phrasing and terminology used herein are for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, a description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1-12. (canceled)

13. A lidar device, comprising:
a first light source configured to emit a first light signal changing within a first time period over a first frequency band at a first frequency rate, and a second light source configured to emit a second light signal changing within the first time period over a second frequency band at a second frequency rate;
a first light splitter configured to split the first light signal into a first split light signal directed into a scanner and a second split light signal directed into a first mixer, and a second light splitter configured to split the second light signal into a third split light signal directed into the scanner and a fourth split light signal directed into a second mixer;
the scanner configured to direct the first split light signal into an environment and receive a first return signal returning from the environment, and direct the third split light signal into the environment and receive a second return signal returning from the environment, the first split light signal and the third split light signal being directed to a first portion of the environment along a first direction within the first time period;
the first mixer configured to mix the second split light signal with the first return signal to generate a first mixed signal with a first beat frequency, and the second mixer configured to mix the fourth split light signal with the second return signal to generate a second mixed signal with a second beat frequency; and
a processor configured to generate a first series of data points, in a point cloud, corresponding to a first series of environmental points in the first portion of the environment based on the first mixed signal with the first beat frequency and the second mixed signal with the second beat frequency, wherein each of the first series of data points includes a measurement of range and/or velocity of the first series of environment points scanned by the scanner within the first time period.

14. The lidar device of claim 13, wherein:
the first light source is further configured to emit a third light signal changing within a second time period over a third frequency band at a third frequency rate, and the second light source is further configured to emit a fourth light signal changing within the second time period over a fourth frequency band at a fourth frequency rate;
the first light splitter is further configured to split the third light signal into a fifth split light signal directed into the scanner and a sixth split light signal directed into the first mixer, and the second light splitter is further configured to split the fourth light signal into a seventh split light signal directed into the scanner and a eighth split light signal directed into the second mixer;
the scanner is further configured to direct the fifth split light signal into the environment and receive a third return signal returning from the environment, and direct the seventh split light signal into the environment and receive a fourth return signal returning from the environment, the fifth split light signal and the seventh split light signal being directed to a second portion of the environment along a second direction within the first time period, and the second direction being different from the first direction;
the first mixer is further configured to mix the sixth split light signal with the third return signal to generate a third mixed signal with a third beat frequency, and the second mixer is further configured to mix the eighth split light signal with the fourth return signal to generate a fourth mixed signal with a fourth beat frequency; and
the processor is further configured to generate a second series of data points, in the point cloud, corresponding to a second series of environmental points in the second portion of the environment based on the third mixed signal with the third beat frequency and the fourth mixed signal with the fourth beat frequency, wherein each of the second series of data points includes a measurement of range and/or velocity of the second series of environment points scanned by the scanner within the second time period.

15. The lidar device of claim 13, wherein a first data point of the first series of data points is generated based on a first group of digital signals determined based on the first mixed signal and the second mixed signal and a second data point of the first series of data points is generated based on a second group of digital signals determined based on the first mixed signal and the second mixed signal, wherein the second group of digital signals comprise a subset of the first group of digital signals and at least one digital signal that is different from the first group of digital signals.

16. The lidar device of claim 13, further comprising a combiner configured to combine the first split light signal and the third split light signal into a combined light signal directed into the scanner when directing the first split light signal and the third split light signal into the scanner.

17. The lidar device of claim 16, wherein the scanner is configured to direct the combined light signal into the environment when directing the first split light signal and the third split light signal into the environment, and receive a combined return signal from the environment when receiving the first return signal and the second return signal from the environment.

18. The lidar device of claim 17, further comprising a third splitter configured to split the combined return signal into the first return signal and the second return signal directed into the first mixer and the second mixer, respectively.

19. The lidar device of claim 13, further comprising:
a first photodetector configured to produce a first analog signal based on the first mixed signal with the first beat frequency, and a second photodetector configured to produce a second analog signal based on the second mixed signal with the second beat frequency; and
a first analog-to-digital converter configured to convert the first analog signal into a first set of digital signals, and a second analog-to-signal converter configured to convert the second analog signal into a second set of digital signals.

20. The lidar device of claim 19, wherein the processor is configured to determine the range and/or velocity of the first series of environment points based on the first set of digital signals and the second set of digital signals.

21. The lidar device of claim 13, wherein the first frequency band and the second frequency band is non-overlapping.

22. The lidar device of claim 14, wherein the first light signal emitted by the first light source changes over the first frequency band at a first positive slope during the first time period and at a first negative slope during the second time period, and the second light signal emitted by the second light source changes over the second frequency band at a second positive slope during the first time period and at a second negative slope during the second time period.

23. The lidar device of claim 14, wherein the first light signal emitted by the first light source changes over the first frequency band at a first positive slope during the first time period and at a first negative slope during the second time period, and the second light signal emitted by the second light source changes over the second frequency band at a second negative slope during the first time period and at a second positive slope during the second time period.

24. The lidar device of claim 14, wherein one of the first frequency rate and the second frequency rate is zero, and the other one of the first frequency rate and the second frequency rate is non-zero.

25. A lidar device, comprising:
a first light source configured to emit a first light signal changing within a first time period at a first frequency rate over a first frequency band, and a second light source configured to emit a second light signal changing within the first time period at a second frequency rate over a second frequency band;
a combiner configured to combine the first light signal and the second light signal to generate a first combined light signal;
a splitter configured to split the first combined light signal into a first split light signal and a second split light signal;
a scanner configured to direct the first split light signal into an environment, and receive a first return light signal returning from the environment, the first split light signal being directed to a first portion of the environment along a first direction;
a mixer configured to mix the first return light signal and the second split light signal to generate a first mixed signal with a first beat frequency corresponding to the first light signal and a second beat frequency corresponding to the second light signal; and
a processor configured to generate a first series of data points, in a point cloud, corresponding to a first series of environmental points in the first portion of the environment based on the first mixed signal with the first beat frequency and the second beat frequency, wherein each of the first series of data points includes a measurement of range and/or velocity of the first series of environment points scanned by the scanner within the first time period.

26. The lidar device of claim 25, wherein:
the first light source is further configured to a third light signal changing within a second time period over a third frequency band at a third frequency rate, and the second light source is further configured to emit a fourth light signal changing within the second time period over a fourth frequency band at a fourth frequency rate;
the combiner is further configured to combine the third light signal and the fourth light signal to generate a second combined light signal;
the splitter is further configured to split the second combined light signal into a third split light signal and a fourth split light signal;
the scanner is further configured to direct the third split light signal into the environment, and receive a second return light signal returning from the environment, the third split light signal being directed to a second portion of the environment along a second direction, and the second direction being different from the first direction;
the mixer is further configured to mix the second return light signal and the fourth split light signal to generate a second mixed signal with a third beat frequency corresponding to the third light signal and a fourth beat frequency corresponding to the fourth light signal; and
the processor is further configured to generate a second series of data points corresponding to a second series of environmental points in the second portion of the environment based on the second mixed signal with the third beat frequency and the fourth beat frequency, wherein each of the second series of data points includes a measurement of range and/or velocity of the second series of environment points scanned by the scanner within the second time period.

27. The lidar device of claim 25, wherein a first data point of the first series of data points is generated based on a first group of digital signals determined based on the first mixed signal and a second data point of the first series of data points is generated based on a second group of digital signals determined based on the first mixed signal, wherein the second group of digital signals comprise a subset of the first group of digital signals and at least one digital signal that is different from the first group of digital signals.

28. The lidar device of claim 25, further comprising:
a photodetector configured to produce a current based on the mixed signal with the first beat frequency and the second beat frequency;
an amplifier configured to convert the current into a voltage; and
an analog-to-digital converter configured to convert the voltage into a set of digital signals.

29. The lidar device of claim 28, wherein the processor is configured to determine the range and/or velocity of the first series of environment points based on the set of digital signals.

30. The lidar device of claim 25, wherein a wavelength difference between a first wavelength corresponding to the first light signal and a second wavelength corresponding to the second light signal corresponds to an upper edge of the first frequency bandwidth and a lower edge of the second frequency bandwidth.

31. The lidar device of claim 30, wherein the mixer is a hybrid mixer configured to generate an in-phase mixed signal with the first beat frequency and the second beat frequency and an quadrature phase mixed signal with the first beat frequency and the second beat frequency.

32. The lidar device of claim 31, further comprising:
a first photodetector configured to generate a first current based on the in-phase mixed signal, and a second photodetector configured to generate a second current based on the quadrature phase mixed signal;
a first amplifier configured to convert the first current into a first voltage, and a second amplifier configured to convert the second current into the second voltage; and
a first analog-to-digital converter configured to convert the first voltage into a first set of digital signals, and a second analog-to-signal converter configured to convert the second voltage into a second set of digital signals.

33. The lidar device of claim 32, wherein the processor is configured to determine the range and/or velocity of the first series of environment points based on the first set of digital signals and the second set of digital signals.

34. A method for operating a lidar device, the method comprising:
providing, via a first light source, a first light signal changing within a first time period over a first frequency band at a first frequency rate, and providing, via a second light source, a second light signal changing within the first time period over a second frequency band at a second frequency rate;
splitting, via a first splitter, the first light signal into a first split light signal, directed into an environment via a scanner, and a second split light signal directed into a first mixer, and splitting, via a second splitter, the second light signal into a third split light signal, directed into the environment via the scanner, and a fourth split light signal directed into a second mixer, the first split light signal and the third split light signal being directed towards a portion of the environment along a first direction;
receiving, via the scanner, a first return signal corresponding to the first split light signal and a second return signal corresponding to the third split light signal;
mixing, via the first mixer, the second split light signal with the first return signal to generate a first mixed signal with a first beat frequency, and mixing, via the second mixer, the fourth split light signal with the second return signal to generate a second mixed signal with a second beat frequency; and
determining, by a processor, a series of data points, in a point cloud, corresponding to a series of environmental points in the portion of the environment based on the first mixed signal with the first beat frequency and the second mixed signal with the second beat frequency, wherein each of the series of data points includes a measurement of range and/or velocity of the series of environment points scanned by the scanner within the first time period.

35. (canceled)
